(19) United States
(12) Patent Application Publication
(10) Pub. No.: US 2023/0368444 A1
(43) Pub. Date: Nov. 16, 2023

(54) RENDERING CUSTOMIZED VIDEO CALL INTERFACES DURING A VIDEO CALL

(71) Applicant: Meta Platforms, Inc., Menlo Park, CA (US)

(72) Inventors: Benjamin Patrick Blackburne, Baldock (GB); Michael Slater, Nottingham (GB); Hannes Luc Herman Verlinde, Ruislip (GB); Andrew James Senior, Redcar (GB)

(21) Appl. No.: 17/663,360

(22) Filed: May 13, 2022

(51) Int. Cl. G06T 11/60; H04L 65/403; H04L 65/1083; G06T 11/00

(52) U.S. Cl. CPC G06T 11/60; H04L 65/403; H04L 65/1083; G06T 11/001; G06T 2200/24

(57) ABSTRACT

Systems, methods, client devices, and non-transitory computer-readable media are disclosed for rendering custom video call interfaces having customizable video cells and/or interactive interface objects during a video call. For example, the disclosed systems can conduct a video call with one or more participant client devices through a streaming channel established for the video call. During the video call, the disclosed systems can render a video cell that portrays a video received from a participant client device in a grid-view display format. Subsequently, upon detecting a user interaction that indicates a request to customize a video call interface, the disclosed systems can render the video cell within a custom video call interface in a self-view display format. In some cases, the client device, via the self-view display format, facilitates various customizations and/or interactions with video cells and other interactive objects displayed on the client device during the video call.

### BACKGROUND

The present disclosure generally relates to video calling systems. Video calling systems allow users to electronically communicate via computing devices (e.g., smart phones, laptops, tablets, desktop computers) through the use of audio and video inputs (e.g., a built-in digital camera, digital web camera). Indeed, recent years have seen an increase in electronic communications through video calls and video conferences that enable multiple users to communicate via computing devices to share both video and audio of the users to one another. However, conventional video calling systems are often limited to non-interactive video calls that simply and rigidly enable user devices to present and view captured videos between the user devices.

### SUMMARY

Embodiments of the present disclosure provide benefits and/or solve one or more of the foregoing or other problems in the art with systems, non-transitory computer-readable media, and methods that render custom video call interfaces having customizable video cells and/or interactive interface objects during a video call. For example, the disclosed systems can conduct a video call with one or more participant client devices through a streaming channel (e.g., a video data channel and an audio data channel) established for the video call. During the video call, the disclosed systems can render a video cell that portrays a video received from a participant client device in a grid-view display format (within a video call interface). In one or more implementations, the disclosed systems provide selectable options to enable various customizations to the video call interface during the video call. Indeed, upon detecting a user interaction that indicates a request to customize the video call interface, the disclosed systems can render the video cell within a custom video call interface in a self-view display format (e.g., a self-view display format that facilitates various customizations and/or interactions with video cells and other objects displayed on a client device during the video call).

Additional features and advantages of one or more embodiments of the present disclosure are outlined in the description which follows, and in part will be obvious from the description, or may be learned by the practice of such example embodiments.

### BRIEF DESCRIPTION OF THE DRAWINGS

The detailed description is described with reference to the accompanying drawings in which:

FIG. 1 illustrates an example environment in which a custom layout video call system can operate in accordance with one or more implementations.

FIG. 2 illustrates an example of a custom layout video call system establishing and facilitating a video call with a custom video call interface in accordance with one or more implementations.

FIG. 3 illustrates a flow diagram of a custom layout video call system establishing a video call with custom video call interfaces in accordance with one or more implementations.

FIG. 4 illustrates an example of a custom layout video call system enabling a client device to utilize a video call streaming channel to modify video cells in accordance with one or more implementations.

FIG. 5 illustrates an example of a custom layout video call system enabling a client device to utilize a video call streaming channel to render an interactive object within a custom video call interface in accordance with one or more implementations.

FIGS. 6A-6B illustrate an example of a custom layout video call system enabling a client device to receive a user interaction requesting a custom video call interface and rendering a custom video call interface with modified video cells in accordance with one or more implementations.

FIGS. 7A-7B illustrate an example of a custom layout video call system enabling a client device to dynamically move video cells within a custom video interface in accordance with one or more implementations.

FIG. 8 illustrates an example of a custom layout video call system enabling a client device to render a material as an interactive object during a video call in accordance with one or more implementations.

FIGS. 9A-9C illustrate an example of a custom layout video call system enabling an electronic drawing application during a video call in accordance with one or more implementations.

FIG. 10 illustrates an example of a custom layout video call system rendering a music development application during a video call in accordance with one or more implementations.

FIG. 11 illustrates an example of a custom layout video call system enabling a client device to render a custom video call interface with media streaming content during a video call in accordance with one or more implementations.

FIGS. 12A-12B illustrate an example of a custom layout video call system enabling a client device to render a media library browsing application during a video call in accordance with one or more implementations.

FIGS. 13A-13B illustrate an example of a custom layout video call system enabling a client device to render a widget as an interactive object to stream and browse music during a video call in accordance with one or more implementations.

FIG. 14 illustrates an example of a custom layout video call system enabling a client device to render video cells and an interactive object within a graphical environment in accordance with one or more implementations.

FIG. 15 illustrates an example of a custom layout video call system enabling a client device to render a video game application as an interactive object within a custom video call interface in accordance with one or more implementations.

FIG. 16 illustrates an example of a custom layout video call system enabling a client device to render a karaoke application with video cells during a video call in accordance with one or more implementations.

FIG. 17 illustrates a flowchart of a series of acts for rendering video cells in custom video call interfaces in accordance with one or more implementations.

FIG. 18 illustrates a block diagram of an example computing device in accordance with one or more implementations.

FIG. 19 illustrates an example environment of a networking system in accordance with one or more implementations.

FIG. 20 illustrates an example social graph in accordance with one or more implementations.

### DETAILED DESCRIPTION

This disclosure describes one or more embodiments of a custom layout video call system that renders customizable video call interfaces with modified video cells and/or interactive objects in the video call interfaces during a video call. For instance, during a video call, the custom layout video call system can detect a selection of an option (or request) to enable various custom video call layouts having customized video cells and/or interactive objects. Then, based on the selected option, the custom layout video call system can render a video cell (of a video call participant) within a custom video call interface in a self-view display format to visually modify (and/or apply dynamic movement to) the video cell. Furthermore, the custom layout video call system can also render interactive objects to emulate various materials and/or interactive applications (e.g., drawing applications, music applications, media streaming applications, and/or browsing applications) within the custom video call interface during a video call.

In one or more embodiments, the custom layout video call system enables a client device to render a custom video call interface with customizable video cells (e.g., from video cells that render videos captured on client devices participating in a video call). For example, in some instances, the custom layout video call system enables the client device to modify visual properties of the video cells such that the video cells have modified sizes, shapes, and/or positions within a custom video call interface. In addition, the custom layout video call system can enable the client device to dynamically move the video cells such that the video cells emulate realistic movements (e.g., bouncing, falling, colliding, sliding, rolling). In order to render customized video cells within a custom video call interface during a video call, the custom layout video call system can enable client devices to modify received videos from other participant devices and/or render video textures from received videos using video processing data provided by the other participant devices.

Additionally, in one or more implementations, the custom layout video call system enables a client device to render a custom video call interface with interactive objects and the video cells for the video call. For example, the custom layout video call system can enable one or more client devices (during a video call) to render interactive objects within a custom video call interface that portray graphic-based materials and/or an interactive application. In some instances, the custom layout video call system can enable the one or more client devices to render an interactive material (e.g., as a background and/or in portions of the custom video call interface) that dynamically changes visually and dynamically moves in response to user interactions from participants during the video call. In one or more implementations, the custom layout video call system enables the one or more client devices to render an interactive application, such as, but not limited to an electronic paint application, an electronic document application, a digital content streaming application, a video game application, a music development application, and/or a media browsing library application with the video cells during a video call.

Furthermore, in one or more embodiments, the custom layout video call system establishes a streaming channel (in addition to a video data channel) to enable client devices to customize video cells and/or integrate interactive objects within a custom video call interface with video cells during a video call. In some cases, the custom layout video call system establishes an additional data channel (e.g., a video processing data channel and/or a data sharing channel) to enable client devices participating on a video call to transmit video processing data, interaction data, and/or other graphical data. Indeed, in one or more embodiments, the custom layout video call system causes the client devices to customize video cells and/or implement interactive objects within a custom video call interface utilizing such transmitted data during the video call. Moreover, in many implementations, the custom layout video call system enables a client device to utilize video data and other transmitted data to process and render videos from other participant devices in a self-view display format (e.g., instead of directly playing received video streams in a default grid-view display format).

As mentioned above, the custom layout video call system provides technical advantages and benefits over conventional systems. For example, the custom layout video call system can establish and enable dynamic and flexible video calls between a plurality of participant devices that include customized, shared, and interactive video call layouts. Indeed, in contrast to many conventional video call systems that are limited to rendering videos portraying participants of a video call in a default grid view, the custom layout video call system enables client devices to initiate various customizations to render (shared) customized video call layouts that may include dynamically changing and moving video cells and/or interactive objects within a video call interface during a video call.

In addition to improved functionality and flexibility of video calls through dynamic video cells and interactive objects within custom video call layouts, the custom layout video call system also enables efficiently and accurately shared video call layout effects across multiple participant devices during a video call. For instance, the custom layout video call system can establish an additional data channel(s) to enable client devices to transmit effect data, interaction data, and/or video processing data to render videos accurately and efficiently within dynamically changing (or moving) video cells during a video call. Moreover, the custom layout video call system can also utilize the additional data channel(s) to enable client devices to transmit effect data, interaction data, and/or video processing data to render shared interactive objects accurately and efficiently during a video call. Indeed, in one or more embodiments, the custom layout video call system can enable, via the additional data channel(s), enable client devices to individually analyze (computationally expensive) raw captured videos (and other interactions) and then transmit such data to enable each client device to locally (and accurately) render video cells from the data and/or interactive objects with shared interactions (e.g., without the computationally expensive analysis of raw data).

As illustrated by the foregoing discussion, the present disclosure utilizes a variety of terms to describe features and benefits of the custom layout video call system. For instance, as used herein, the term “video call” refers to an electronic communication in which video data is transmitted between a plurality of computing devices. In particular, in one or more embodiments, a video call includes an electronic communication between computing devices that transmits and presents videos (and audio) captured on the computing devices.

As used herein, the term “custom video call interface” refers to a modified video call interface. In particular, the term “custom video call interface” can refer to a graphical user interface that facilitates a video call with modified features to include customized video cells and/or interactive objects during the video call. For example, a custom video call interface can include a graphical user interface with multiple video cells and/or interactive objects rendered outside of a conventional or default grid-view display format.

In addition, as used herein, the term “video cell” refers to a graphical object (or frame) that surrounds (or encompasses) a digital video (or video texture). In particular, the term “video cell” can refer to a graphical frame that surrounds (or fits) a digital video portraying a video call participant. In one or more embodiments, a custom layout video call system enables a client device to introduce visual and/or movement-based changes to a video cell (e.g., via visual properties and/or dynamic movement).

As used herein, the term “visual property” refers to one or more data points, values, and/or representations that indicate a visual characteristic of a graphical object. For instance, the term “visual property” can include a size, a shape, and/or a position of a graphical object (e.g., a video cell). In or more embodiments, the custom layout video call system enables a client device to modify visual properties of a video cell by modifying a size, shape, or position of the boundaries of the video cell (that surrounds or frames a digital video).

As further used herein, the term “dynamic movement” refers to movement behaviors or movement characteristics of a graphical object. In particular, the term “dynamic movement” can refer to various types of (e.g., realistic and/or animated) movement of a graphical object (e.g., a video cell) within a graphical user interface (e.g., a custom video call interface). For example, custom layout video call system can enable a client device to dynamically move a video cell to emulate various movements of the video cell, such as, but not limited to bouncing, falling, rotating, bumping, colliding, and/or sliding. In one or more implementations, the custom layout video call system 106 can enable a client device to dynamically move a video cell by snapping a video cell to an edge of a video call interface and/or to another video cell. In some cases, the custom layout video call system enables a client device to utilize (or apply) one or more movement properties to dynamically move a video cell. For example, the custom layout video call system can utilize movement properties, such as, but not limited to mass values, collision boundaries, gravity values, friction values, elasticity values for the video cell. Indeed, the custom layout video call system can enable a client device to utilize (or apply) movement properties with a video cell to emulate the various movement characteristics.

Furthermore, as used herein, the term “self-view display” refers to a display of a video capture that is captured and displayed on the same client device. In particular, as used herein, the term “self-view display” can refer to a display of a camera capture buffer that displays, within a client device, a video captured on the client device. In one or more embodiments, the custom layout video call system enables a client device to display multiple (customized) video cells from other participant devices and/or interactive objects within a self-view display to create the perception that the multiple video cells (and interactive objects) are captured directly on the client device (e.g., a view similar to a video capture from a camera buffer). As used herein, the term “grid-view display” refers to a display having multiple static partitions to separately display videos from different client devices participating in a video call.

As further used herein, the term “interactive object” refers to a graphical object and/or application that facilitates user interaction. In particular, the term “interactive object” refers to a graphical object and/or application that is rendered within a custom video call layout interface and updates upon receiving interaction. For instance, the custom layout video call system can enable a client device to render an interactive object for display within a custom video call layout interface (with or around video cells) and, upon receiving a user interaction with the interactive object, the client device can update the interactive object. In one or more instances, an interactive object includes, but is not limited to, graphical objects (e.g., materials, AR effects) and/or interactive applications (e.g., electronic paint applications, electronic document applications, digital content streaming applications, video game applications, music development applications, or media browsing library applications).

As used herein, the term “channel” refers to a medium or stream utilized to transfer data (e.g., data packets) between client devices and/or a network. In one or more embodiments, the term “streaming channel” (sometimes referred to as “video call streaming channel”) refers to a medium or stream (or a collection of streams) utilized to transfer data between client devices to establish a video call. In certain implementations, a streaming channel includes various combinations of a video data channel, an audio data channel, a video processing data channel, and/or a shared data channel (e.g., an AR data channel).

In some cases, the term “video data channel” can refer to a medium or stream utilized to transfer video data between client devices and/or a network. Indeed, the video data channel can enable the transfer of a continuous stream of video data between client devices to display a video (e.g., a collection of moving image frames). In some cases, a video data channel can also include audio data for the captured video. In addition, the term “audio data channel” can refer to a medium or stream utilized to transfer audio data between client devices and/or a network that enables the transfer of a continuous stream of audio between client devices to play audio content (e.g., a captured recording from a microphone of a client device).

In addition, the term “shared data channel” refers to a medium or stream utilized to transfer shared data between client devices and/or a network (for a video call). For example, the term “shared data channel” can enable the transfer of a continuous stream (and/or a situational transmission and/or request) of shared data between client devices to communicate content (e.g., interactive objects, AR data, video cell effects), interactions with objects or effects (e.g., user interaction data), and/or object information (e.g., video cell visual and movement properties, interactive object updates, layout data). In some implementations, the shared data channel utilizes data-interchange formats such as JavaScript Object Notation (JSON), real time protocol (RTP), and/or extensible markup language (XML) to write, transmit, receive, and/or read data from the shared data channel.

Furthermore, the term “augmented reality data channel” refers to a medium or stream utilized to transfer AR data between client devices and/or a network (for a video call). For example, the term “augmented reality data channel” can enable the transfer of a continuous stream (and/or a situational transmission and/or request) of AR data between client devices to communicate AR content and interactions with AR content between the client devices (e.g., AR elements, AR environment scenes, interactions with AR, AR object vectors). In some cases, the shared AR video call system utilizes data-interchange formats such as JavaScript Object Notation (JSON), real time protocol (RTP), and/or extensible markup language (XML) to write, transmit, receive, and/or read AR data from the AR data channel.

Moreover, as used herein, the term “augmented reality effect” refers to one or more AR elements that present (or display) an interactive, manipulatable, and/or spatially aware graphical animation or AR element. In particular, the term “augmented reality effect” can include a graphical animation that realistically interacts with a person (or user) or with a scene (or environment) captured within a video such that the graphical animation appears to realistically exist within the environment (e.g., a graphic-based environment or an environment captured in a video). As an example, an augmented reality effect can include graphical characters, objects (e.g., vehicles, plants, buildings), and/or modifications to persons captured within the video call (e.g., wearing a mask, change to appearance of a participating user on a video call, change to clothing, an addition of graphical accessories, a face swap).

In some cases, an AR element can include visual content (two dimensional and/or three dimensional) that is displayed (or imposed) by a computing device (e.g., a smartphone or head mounted display) on a video (e.g., a live video feed) of the real world (e.g., a video capturing real world environments and/or users on a video call). In particular, an AR element can include a graphical object, digital image, digital video, text, and/or graphical user interface displayed on (or within) a computing device that is also rendering a video or other digital media. For example, an AR element can include a graphical object (e.g., a three dimensional and/or two-dimensional object) that is interactive, manipulatable, and/or configured to realistically interact (e.g., based on user interactions, movements, lighting, shadows) with a graphic-based environment or an environment (or person) captured in a video of a computing device. Indeed, in one or more embodiments, an AR element can modify a foreground and/or background of a video and/or modify a filter of a video.

Additionally, as used herein, the term “augmented reality scene” (sometimes referred to as an “AR environment”) refers to one or more AR effects (e.g., AR elements) that are interactive, manipulatable, and/or configured to realistically interact with each other and/or user interactions detected on a computing device. In some embodiments, an augmented reality environment scene includes one or more augmented reality elements that modify and/or portray a graphical environment (a two-dimensional and/or a three-dimension environment) in place of a real-world environment captured in a video of a computing device. As an example, the shared AR scene video call system can render an augmented reality environment scene to portray one or more participants of a video call to be within a graphical environment as AR effects (e.g., the participants as AR-based characters in space, underwater, at a campfire, in a forest, at a beach) utilizing captured videos portraying the participants. In some cases, the shared AR scene video call system further enables augmented reality elements within the augmented reality environment scene to be interactive, manipulatable, and/or configured to realistically interact to user interactions detected on a plurality of participant devices.

In one or more embodiments, the custom layout video call system can enable a client device to transmit a split video frame through a video data channel. As used herein, the term “split video frame” refers to a video frame of a video that includes video data and video processing data. For example, the term “split video frame” can refer to a modified video frame that displays (or includes) an image or frame (from the video) in a first portion and video processing data for the image (from the video) in a second portion. For example, a split video frame can include a frame from a video as a first half of the split video frame and a segmentation mask for the image on a second half of the split video frame.

Furthermore, as used herein, the term “video processing data channel” refers to a medium or stream utilized to transfer video processing data between client devices and/or a network (for a video call). For instance, the term “video processing data channel” can enable the transfer of a continuous stream (and/or a situational transmission and/or request) of video processing data between client devices to communicate data from an analysis of (raw) videos captured at the individual client device level. In some implementations, the custom layout video call system utilizes data-interchange formats such as JavaScript Object Notation (JSON), real time protocol (RTP), and/or extensible markup language (XML) to write, transmit, receive, and/or read video processing data from the video processing data channel.

As also used herein, the term “video processing data” refers to data representing properties of a video. In particular, the term “video processing data” can refer to data representing properties or characteristics of one or more objects depicted within a video. For example, video processing data can include face tracking (or face recognition) data that indicates features and/or attributes of one or more faces depicted within a video (e.g., vectors and/or points that represent a structure of a depicted face, bounding box data to localize a depicted face, pixel coordinates of a depicted face). In addition, video processing data can include segmentation data that indicates salient objects, background pixels and/or foreground pixels, and/or mask data that utilize binary (or intensity values) per pixel to represent various layers of video frames (e.g., to distinguish or focus on objects depicted in a frame, such as hair, persons, faces, and/or eyes).

In addition, video processing data can include alpha channel data that indicates degrees of transparency for various color channels represented within video frames. Furthermore, video processing data can include participant metadata that can classify individual participants, label individual participants (e.g., using participant identifiers), participant names, statuses of participants, and/or number of participants. The video processing data can also include metadata for the video stream (e.g., a video resolution, a video format, a camera focal length, a camera aperture size, a camera sensor size). Indeed, the custom layout video call system can enable client devices to transmit video processing data that indicates various aspects and/or characteristics of a video or objects depicted within a video.

As used herein, the term “video texture” refers to a graphical surface that is applied to a computer graphics object to superimpose the computer graphics object (e.g., a video cell) with a video. In one or more embodiments, the term “video texture” refers to a computer graphics surface generated from a video that overlays or superimposes (i.e., maps) a video onto a graphics-based object (e.g., a video cell, a three-dimensional object or scene, a still image, or a two-dimensional animation or scene). In some embodiments, the custom layout video call system enables a client device to render a video as a video texture within a video cell such that the video texture depicts a captured video of a participant superimposed onto a customizable video cell.

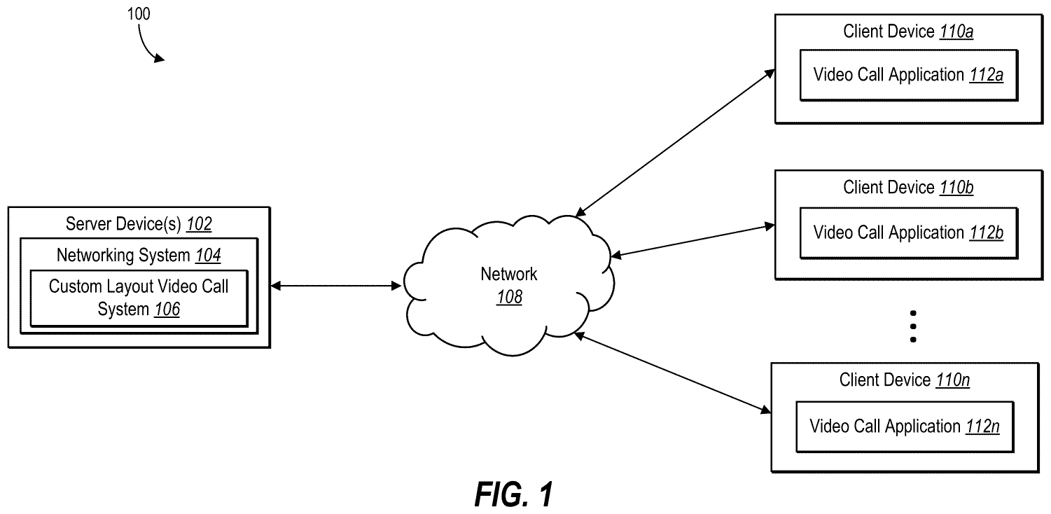

Additional detail regarding the custom layout video call system will now be provided with reference to the figures. For example, FIG. 1 illustrates a schematic diagram of an exemplary system environment (“environment”) 100 in which a custom layout video call system 106 can be implemented. As illustrated in FIG. 1, the environment 100 includes a server device(s) 102, a network 108, and client devices 110a-110n.

Although the environment 100 of FIG. 1 is depicted as having a particular number of components, the environment 100 can have any number of additional or alternative components (e.g., any number of server devices and/or client devices in communication with the custom layout video call system 106 either directly or via the network 108). Similarly, although FIG. 1 illustrates a particular arrangement of the server device(s) 102, the network 108, the client devices 110a-110n, various additional arrangements are possible.

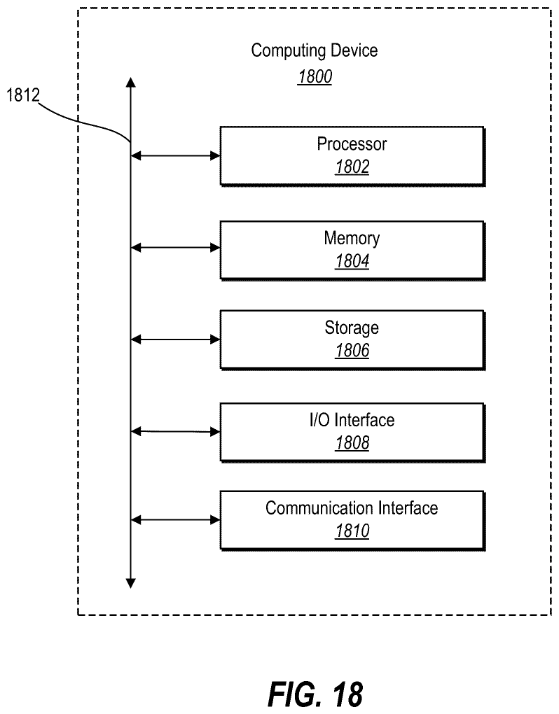

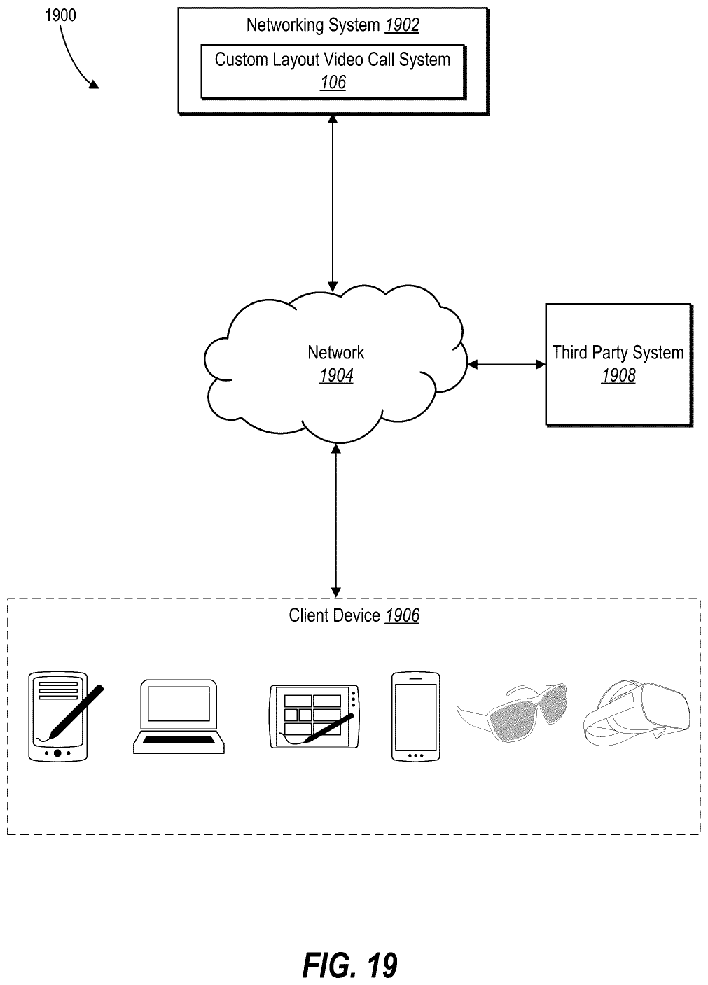

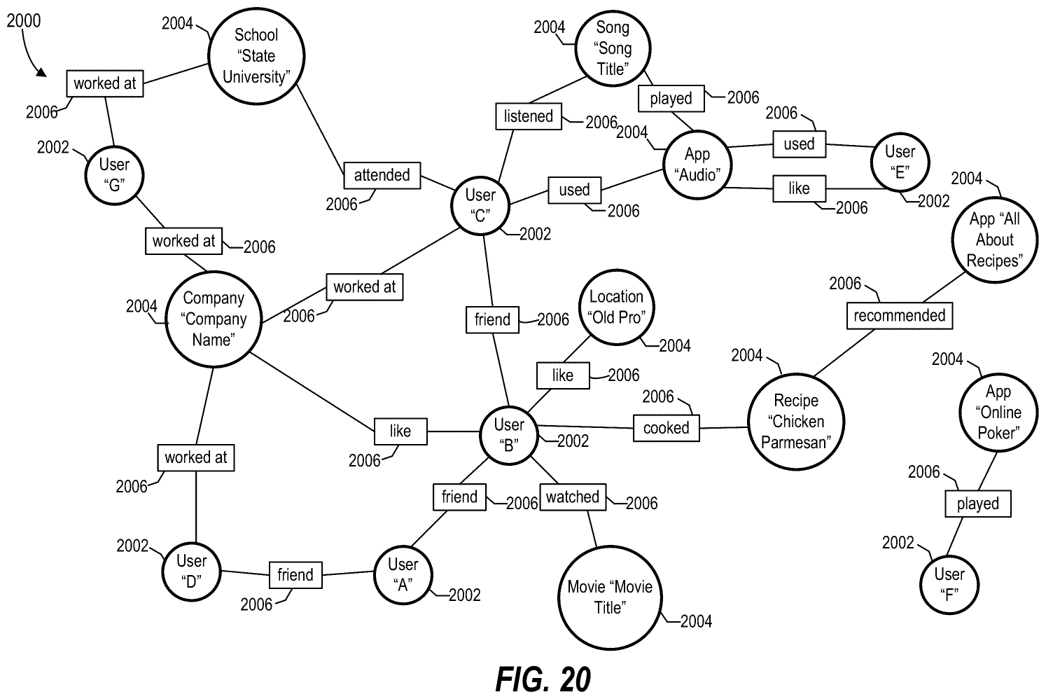

The server device(s) 102, the network 108, and the client devices 110a-110n may be communicatively coupled with each other either directly or indirectly (e.g., through the network 108 discussed in greater detail below in relation to FIGS. 19 and 20). Moreover, the server device(s) 102 and the client devices 110a-110n may include a variety of computing devices (including one or more computing devices as discussed in greater detail with relation to FIG. 18).

As mentioned above, the environment 100 includes the server device(s) 102. In one or more embodiments, the server device(s) 102 generates, stores, receives, and/or transmits digital data, including digital data related to video data (e.g., video cells, videos), video processing data, and/or shared data (e.g., interactive object data, AR data) for video calls between client devices (e.g., client devices 110a-110n). In some embodiments, the server device(s) 102 comprises a data server. In one or more embodiments, the server device(s) 102 comprises a communication server or a web-hosting server.

As shown in FIG. 1, the server device(s) 102 includes a networking system 104. In particular, the networking system 104 can provide a digital platform (e.g., a social network, instant messenger platform, extended-reality environment) that includes functionality through which users of the networking system 104 can connect to and/or interact with one another. For example, the networking system 104 can register a user (e.g., a user of one of the client devices 110a-110n). The networking system 104 can further provide features through which the user can connect to and/or interact with co-users. For example, the networking system 104 can provide messaging features, chat features, and/or video call features through which a user can communicate with one or more co-users. The networking system 104 can also generate and provide groups and communities through which the user can associate with co-users.

In one or more embodiments, the networking system 104 comprises a social networking system, but in other embodiments the networking system 104 may comprise another type of system, including but not limited to an e-mail system, video calling system, search engine system, e-commerce system, banking system, metaverse system, or any number of other system types that use user accounts. For example, in some implementations, the networking system 104 generates and/or obtains data for an extended-reality device (e.g., client devices 110a-110n via the server device(s) 102).

In one or more embodiments where the networking system 104 comprises a social networking system, the networking system 104 may include a social graph system for representing and analyzing a plurality of users and concepts. A node storage of the social graph system can store node information comprising nodes for users, nodes for concepts, and nodes for items. An edge storage of the social graph system can store edge information comprising relationships between nodes and/or actions occurring within the social networking system. Further detail regarding social networking systems, social graphs, edges, and nodes is presented below with respect to FIGS. 19 and 20.

Furthermore, as shown in FIG. 1, the server device(s) 102 includes the custom layout video call system 106. In one or more embodiments, the custom layout video call system 106 establishes a video call streaming channel between client devices to enable a video call between the client devices. In addition, in one or more implementations, the custom layout video call system 106 enables client devices to, during a video call, render custom video call layouts having dynamically changing and/or dynamically moving video cells for the video call participants. In some implementations, the custom layout video call system 106 also enables the client devices to, during a video call, render custom video call layouts by introducing interactive objects that are rendered (and shared) by one or more of the participating client devices. Additionally, the custom layout video call system 106 is implemented as part of a social networking system that facilitates electronic communications such as instant messaging, video calling, and/or social network posts (e.g., as discussed in greater detail with relation to FIGS. 19 and 20).

Moreover, in one or more embodiments, the environment 100 includes the client devices 110a-110n. For example, the client devices 110a-110n can include computing devices that are capable of interacting with the custom layout video call system 106 to conduct video calls (and/or) other electronic communications with one or more other client devices. Indeed, the client devices 110a-110n can capture videos from digital cameras of the client devices 110a-110n and further render custom video call layouts with dynamic video cells and/or interactive objects (as described herein). In some implementations, the client devices 110a-110n include at least one of a smartphone, a tablet, a desktop computer, a laptop computer, a head mounted display device, or other electronic device (including one or more computing devices as discussed in greater detail with relation to FIG. 18).

Additionally, in some embodiments, each of the client devices 110a-110n is associated with one or more user accounts of a social network system (e.g., as described in relation to FIGS. 19 and 20). In one or more embodiments, the client devices 110a-110n include one or more applications (e.g., the video call applications 112a-112n) that are capable of interacting with the custom layout video call system 106, such as by initiating video calls, transmitting video data, video processing data, and/or shared data and/or receiving video data, video processing data, and/or shared data for custom video layout interfaces. In addition, the video call applications 112a-112n are also capable of rendering custom video call layouts with dynamic video cells and/or interactive objects (as described herein). In some instances, the video call applications 112a-112n include software applications installed on the client devices 110a-110n. In other cases, however, the video call application 112a-112n includes a web browser or other application that accesses a software application hosted on the server device(s) 102.

The custom layout video call system 106 can be implemented in whole, or in part, by the individual elements of the environment 100. Indeed, although FIG. 1 illustrates the custom layout video call system 106 implemented with regard to the server device(s) 102, different components of the custom layout video call system 106 can be implemented by a variety of devices within the environment 100. For example, one or more (or all) components of the custom layout video call system 106 can be implemented by a different computing device (e.g., one of the client devices 110a-110n) or a separate server from the server device(s) 102.

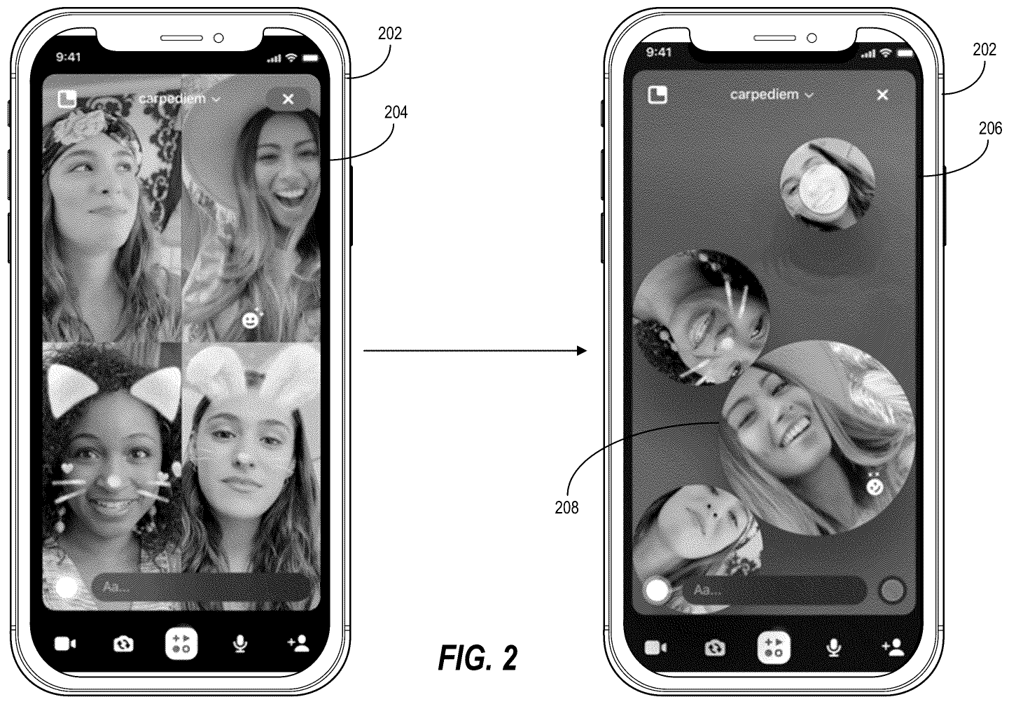

As mentioned above, the custom layout video call system 106 can enable client devices to render customizable video call interfaces during a video call. For example, FIG. 2 illustrates the custom layout video call system 106 enabling a client device participating in a video call to render a customizable video call interface with multiple video cells. As shown in FIG. 2, the custom layout video call system 106 enables the client device 202 to display a video call interface 204 for a video call between participant devices (e.g., utilizing a grid-view display format). As further shown in FIG. 2, the custom layout video call system 106 enables the client device 202 to render (from the video call interface 204) a customized video call interface 206.

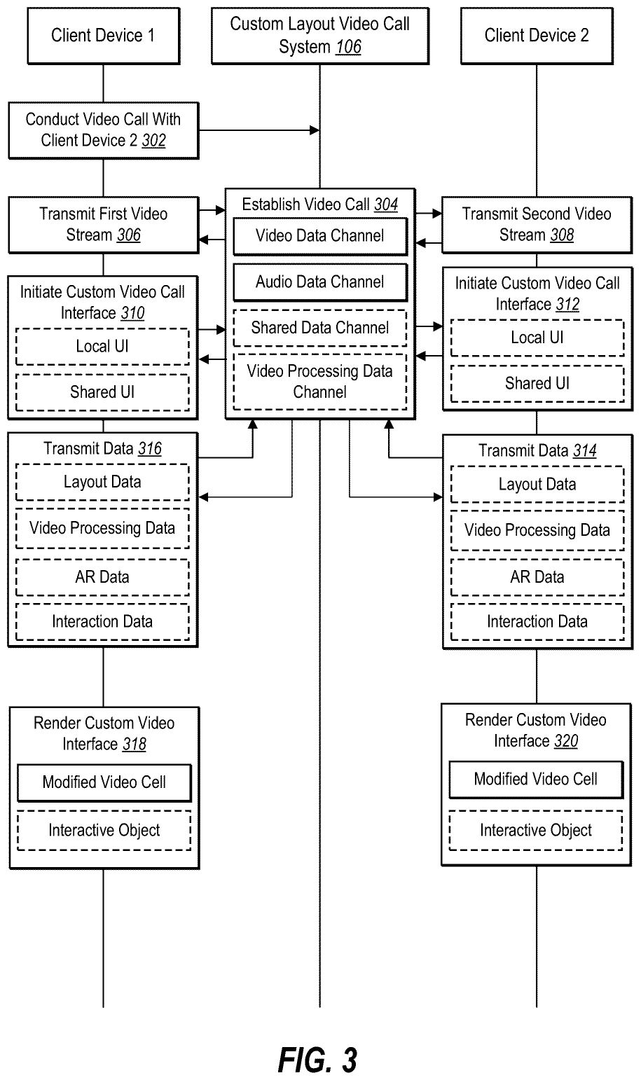

As shown in FIG. 2, the custom layout video call system 106 enables the client device 202 to render the customized video call interface 206 utilizing a self-view display format to render video cells 208 from video data provided by participant client devices. For example, as shown in FIG. 2, the custom layout video call system 106 enables the client device 202 to render customized video cells 208 that have modified visual properties and dynamic movement (e.g., round shapes with a bouncing and colliding effect) during the video call. Indeed, the custom layout video call system 106 can enable a client device to render customized video cells with various visual changes and/or various dynamic movement behaviors as described in greater detail below (e.g., in relation to FIGS. 3, 4, and 6-7). Additionally, the custom layout video call system 106 can also enable a client device to render interactive objects within a customized video call interface during a video call as described in greater detail below (e.g., in relation to FIGS. 3, 5, and 8-16).

As mentioned above, the custom layout video call system 106 can enable client devices to render customizable video call interfaces with modified video cells and/or interactive objects in the video call interfaces during a video call. FIG. 3 illustrates a flow diagram of the custom layout video call system 106 establishing a video call with customizable video call interfaces between client devices. For instance, as shown in FIG. 3, the custom layout video call system 106 can enable client devices to transmit various types of data to render video cells within customizable video call interfaces.

Indeed, as shown in FIG. 3, the custom layout video call system 106 receives, in an act 302, a request to conduct a video call with a client device 2 from a client device 1 (e.g., a request to initiate a video call). Then, as shown in act 304 of FIG. 3, the custom layout video call system 106 establishes a video call between the client device 1 and the client device 2 (e.g., which can include a video data channel, an audio data channel, a video processing data channel, and/or an AR data channel).

Subsequently, as shown in act 306 of FIG. 3, the client device 1 transmits a first video stream (e.g., a video stream captured on the client device 1) to the client device 2 through the video data channel and the audio data channel. As further shown in act 308 of FIG. 3, the client device 2 transmits a second video stream (e.g., a video stream captured on the client device 2) to the client device 1 through the video data channel and the audio data channel. Indeed, the client device 1 can render the first and second video stream to facilitate the video call. Likewise, the client device 2 can also render the first and second video stream to facilitate the video call.

As further shown in act 310 of FIG. 3, the client device 1 initiates a custom video call interface (e.g., based on a user interaction on the client device 1 requesting a custom video call interface). In some cases, the client device 1 can initiate a custom video call interface as a local user interface (UI) in which the client device 1 independently renders a custom video call interface during the video call. As further shown in act 312 of FIG. 3, the client device 2 initiates a custom video call interface. Indeed, in one or more embodiments, the client device 2 can initiate a custom video call interface as a local user interface (UI) in which the client device 2 independently renders a separate custom video call interface during the video call.

In one or more implementations, the client devices utilize a coordination signal (e.g., a Boolean flag, binary trigger) to initialize a custom video call interface (in synchronized manner). For instance, one or more client devices receive a coordination signal (from other client devices) and wait until each client device is indicated as ready to initialize a custom video call interface to synchronize the initialization and rendering of the custom video call interface across the multiple client devices on the video call. Upon receiving an initialized message (e.g., as a coordination signal) from each client device on a video call, individual client devices can continue to render custom video call interfaces utilizing received video data and other transmitted data from the video call streaming channels.

In reference to FIG. 3, the client device 1 can render a custom video call interface using transmitted data 314 (from the client device 2). As shown in FIG. 3, the client device 1 can receive transmitted data 314 through streaming channels established by the custom layout video call system 106 (e.g., video data channel, audio data channel, shared data channel, video processing data channel). For example, as shown in act 318 of FIG. 3, the client device 1 can render modified video cells using the transmitted data 314 (e.g., video processing data). In some cases, as shown in the act 318 of FIG. 3, the client device 1 can also render an interactive object within the custom video interface. As further shown in act 320 of FIG. 3, the client device 2 can also (independently) utilize transmitted data 316 (from the client device 1) through the streaming channels established by the custom layout video call system 106 to render modified video cells and/or an interactive object.

In some implementations, as shown in FIG. 3, the client device 1 (in the act 310) and the client device 2 (in the act 312) can initiate a shared custom video call interface (e.g., via a shared UI). In particular, both the client device 1 and the client device 2 utilize transmitted data to render shared modified video cells and/or a shared interactive object during the video call such that the rendered interface is synchronized (or co-existing) between the client devices. For example, the client devices can render the same modified video cells and/or interactive object during the video call (e.g., with synchronized updates and visual properties). In some cases, the client devices can render random (or independent) placements of the modified video cells and/or interactive object while synchronizing interaction-based updates (e.g., modifications to an interactive object and/or interactions with an AR effect).

In order to initiate a shared custom video call interface, the client device 1 can transmit data (e.g., layout data, video processing data, AR data, interaction data) to the client device 2 such that the client device 2 responds to updates on the client device 1 during the video call. Additionally, the client device 2 can transmit data (e.g., layout data, video processing data, AR data, interaction data) to the client device 1 such that the client device 1 responds to updates on the client device 2 during the video call. Indeed, the client devices utilize the transmitted data to render modified video cells and/or interactive objects that are synchronized (or co-exist) during the video call. For example, the client devices can transmit data, such as, but not limited to, layout data (e.g., visual properties and placement of video cells and interactive objects), video processing data (e.g., segmentation data, face tracking data from captured videos), AR data (e.g., AR effect information or AR environment information that facilitates rendering of AR effects or AR environments), and/or interaction data (e.g., user interactions identified with video cells, interactive objects, and/or with the custom video call interface).

In one or more embodiments, the custom layout video call system 106 enables client devices to utilize videos (and/or video processing data) from participant devices to render modified video cells. For example, the custom layout video call system 106 can enable a client device to render modified video cells (e.g., with modified visual properties and/or dynamic movement) utilizing videos (e.g., via modification and/or video texture rendering) as described in Benjamin Blackburne et al., Generating Shared Augmented Reality Scenes Utilizing Video Textures from Video Streams of Video Call Participants, U.S. patent application Ser. No. 17/662,197 (filed May 5, 2022) (hereinafter “Blackburne”), the contents of which are hereby incorporated by reference in their entirety.

Furthermore, in one or more implementations, the custom layout video call system 106 enables client devices to utilize various transmitted data from participant devices to update video cells and/or interactive objects within a custom video call interface. For instance, the custom layout video call system 106 can enable a client device to transmit and/or receive data (e.g., interaction data, layout data, effects data) to render shared video cells, shared interactive objects, and/or other shared effects (e.g., AR effects) as described in Jonathan Michael et al., Utilizing Augmented Reality Data Channel to Enable Shared Augmented Reality Video Calls, U.S. patent application Ser. No. 17/650,484 (filed Feb. 9, 2022) (hereinafter “Sherman”), the contents of which are hereby incorporated by reference in their entirety.

As further mentioned above, the custom layout video call system 106 enables client devices to transmit data to render shared (or localized) custom video call interfaces with modified video cells and/or interactive objects utilizing various streaming channels. For instance, the custom layout video call system 106 can enable a client device to receive video data and other data via separate streaming channels. In some instances, the client device(s) transmits video data within a video data channel (e.g., to transmit a raw and/or high-resolution video stream) while separately transmitting other data (e.g., video processing data, interaction data, shared data) via a data channel. For example, the client device(s) can receive video data and other data (via the separate video call streaming channels) and utilize the two sets of data to render videos of participants of the video call within customized video call interfaces (having modified video cells and/or interactive objects).

To illustrate, in one or more embodiments, the csv establishes and utilizes a data channel that facilitates a real time transfer of additional data during a video call. For instance, during a video call, the custom layout video call system 106 can establish a data channel that facilitates the transmission (and reception) of additional data (e.g., in addition to video and audio data) during a video call to share video processing data and/or interactive object data determined (or identified) from video or user interactions directly on the capturing client device.

In some embodiments, the custom layout video call system 106 establishes a data channel to utilize one or more data-interchange formats to facilitate the transmission of additional data within the data channel. For instance, the custom layout video call system 106 can enable the data channel to transmit data in formats, such as, but not limited to JavaScript Object Notation (JSON), plain text, and/or Extensible Markup Language (XML). In addition, in one or more embodiments, the custom layout video call system 106 establishes the data channel utilizing an end-to-end network protocol that facilitates the streaming of real time data to stream data between a plurality of client devices. For example, the custom layout video call system 106 can enable the data channel to transmit data via end-to-end network protocols, such as, but not limited to Real-Time Transport Protocol (RTP), real time streaming protocol (RTSP), real data transport (RDT), and/or another data sync service.

In some embodiments, the custom layout video call system 106 enables client devices to utilize JSON formatted message broadcasting via the data channel to communicate data. For example, the custom layout video call system 106 can, during a video call, establish a data message channel capable of transmitting JSON formatted messages as the data channel. Indeed, the custom layout video call system 106 can establish a data message channel that persist during one or more active custom video call interfaces during the video call. In addition, the custom layout video call system 106 can establish the data message channel as a named, bidirectional communication data channel that facilitates requests to transmit data and requests to receive data. For instance, the custom layout video call system 106 can enable a data message channel capable of transmitting text-based or data-based translations data (e.g., face tracking coordinates, segmentation mask pixel values, pixel color values, participant metadata, user interaction flags, user interaction positions, effect identifiers for interactions).

In some cases, the custom layout video call system 106 can utilize a JSON formatted message as a JSON object that includes one or more accessible values. In particular, the JSON object can include one or more variables and/or data references (e.g., via Booleans, strings, numbers) that can be accessed via a call to the particular variable. For example, the custom layout video call system 106 can facilitate the transmission and reception of JSON objects that are accessed to determine information of data provided by participant devices.

In one or more embodiments, the custom layout video call system 106 can utilize a video or image communication channel as a data channel. For example, the custom layout video call system 106 can establish a data channel that facilitates the transmission of videos, video frames, and/or images as the data channel (e.g., to represent various data, such as interaction data, layout data, and/or video processing data as videos or images). In addition, the custom layout video call system 106 can establish a data channel that utilizes a real-time synchronous data channel (e.g., a sync channel). In some cases, the custom layout video call system 106 can establish a data channel that utilizes an asynchronous data channel that broadcasts data to client devices regardless of synchronization between the client devices.

Moreover, the custom layout video call system 106 can provide an application programming interface (API) to one or more client devices to communicate data with each other and custom layout video call system 106 during a video call. To illustrate, the custom layout video call system 106 can provide an API that includes calls to communicate requests, transmissions, and/or notifications for videos and interactions across a data channel established by the custom layout video call system 106. Indeed, client devices (and/or the custom layout video call system 106) can utilize an API to communicate a variety of data during a video call to render custom video call interfaces in accordance with one or more embodiments herein.

In some cases, a client device includes a client device layer for the video call streams established by the custom layout video call system 106. In particular, a client device can utilize a client device layer (e.g., a layer within an API and/or a network protocol) that controls the transmission and/or reception of data via the data channel. For instance, a client device can utilize a client device layer to receive and filter data that is broadcast (or transmitted) via the data channel from one or more client devices participating in a video call. In particular, in one or more embodiments, client devices transmit data via the data channel to each client device participating on a (same) video call. Moreover, a client device can identify the transmitted data utilizing a client device layer and filter the data (e.g., to utilize or ignore the data). For instance, a client device can utilize a client device layer to filter data based on participant identifiers corresponding to the data (as described below) to determine which participants to include within a video cell.

Furthermore, in one or more embodiments, the custom layout video call system 106 establishes a data channel utilizing a streaming channel as described in Blackburne and/or Sherman. For example, the custom layout video call system 106 can establish a video processing data channel as a data channel as described by Sherman. Moreover, the custom layout video call system 106 can establish an AR data channel (or a shared data channel) as a data channel as described by Blackburne.

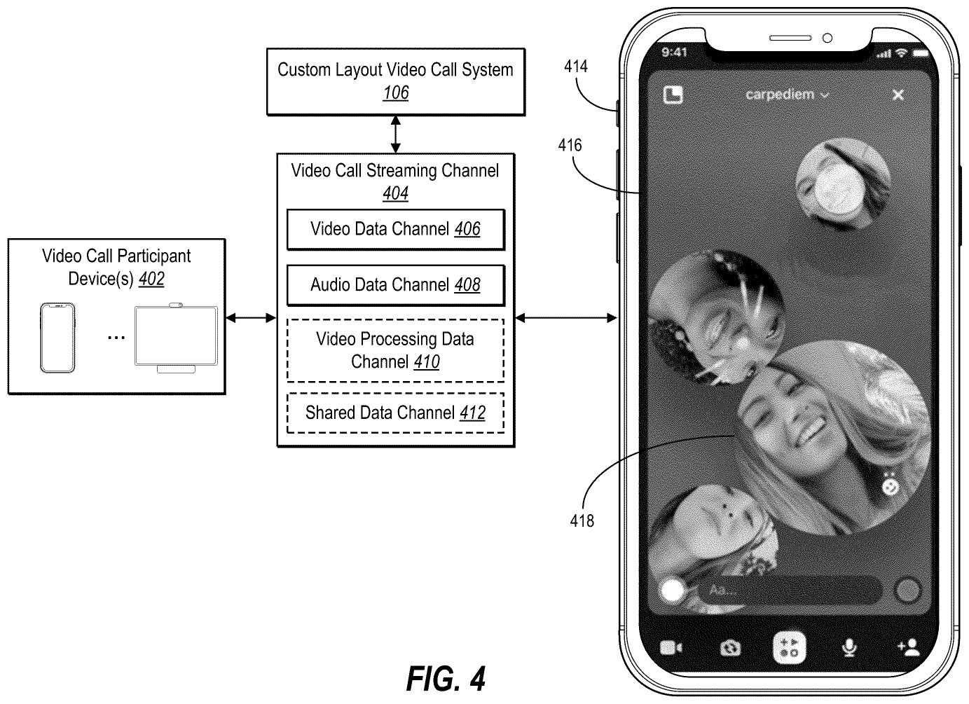

As mentioned above, the custom layout video call system 106 can enable a client device to render video cells within custom video interfaces. Indeed, in one or more embodiments, the custom layout video call system 106 enables a client device to render customizable video cells within custom video interface during a video call. For example, FIG. 4 illustrates the custom layout video call system 106 enabling a client device to render customizable video cells within a custom video interface.

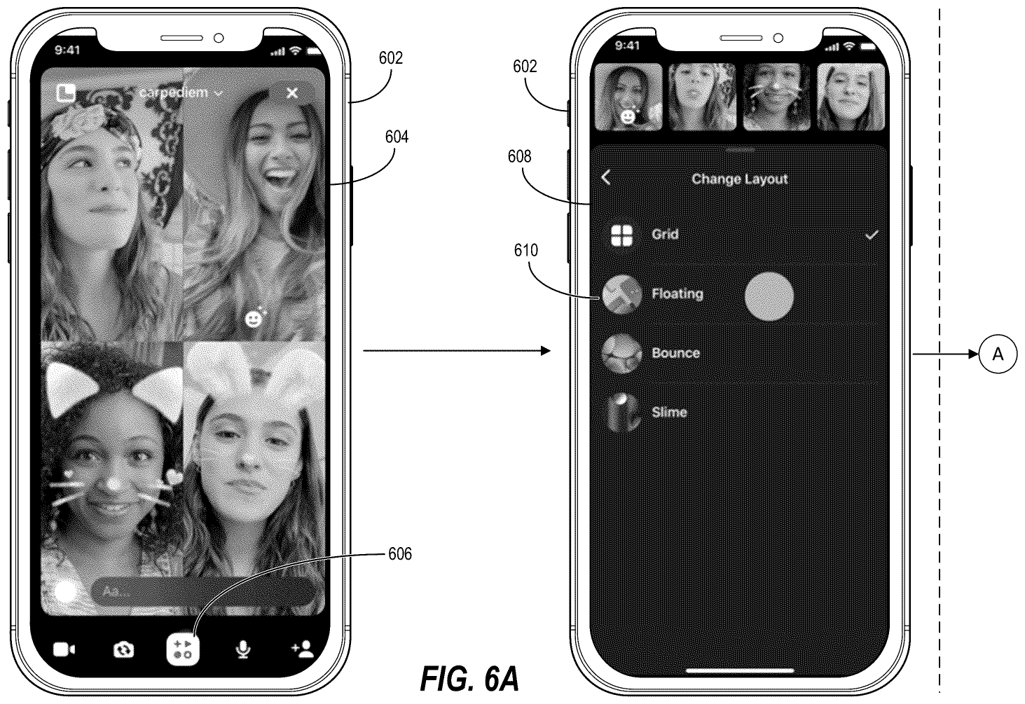

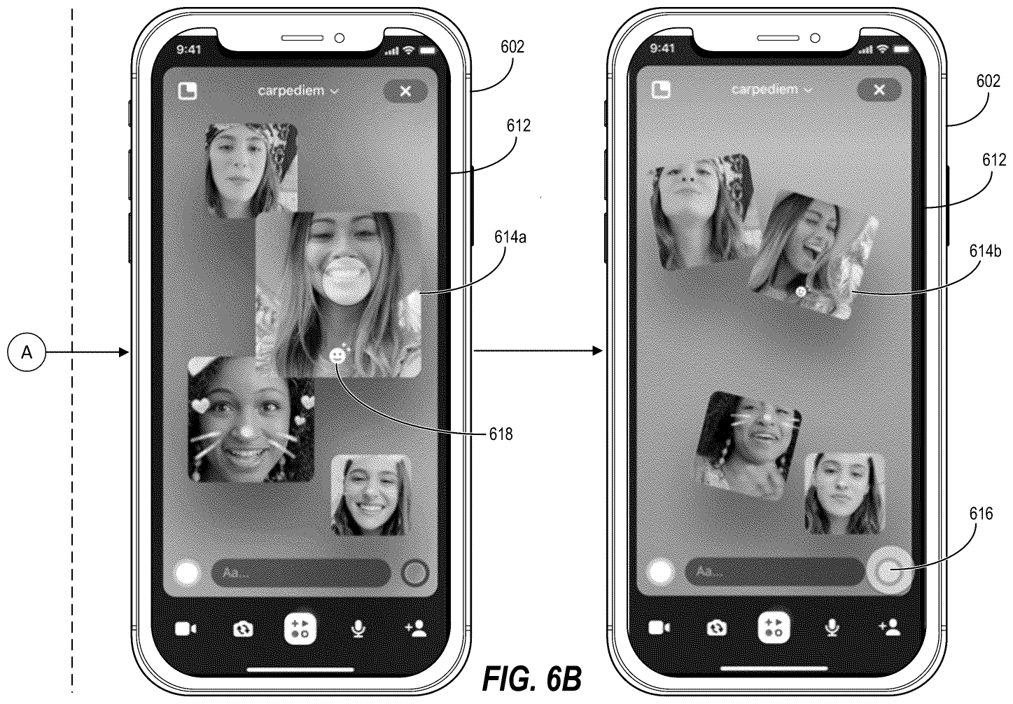

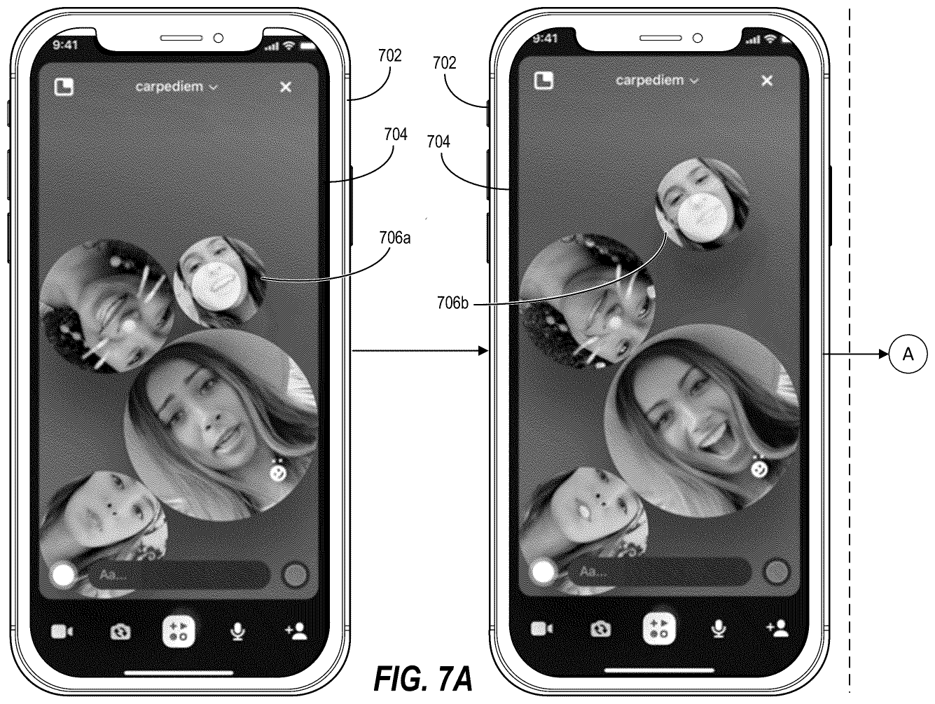

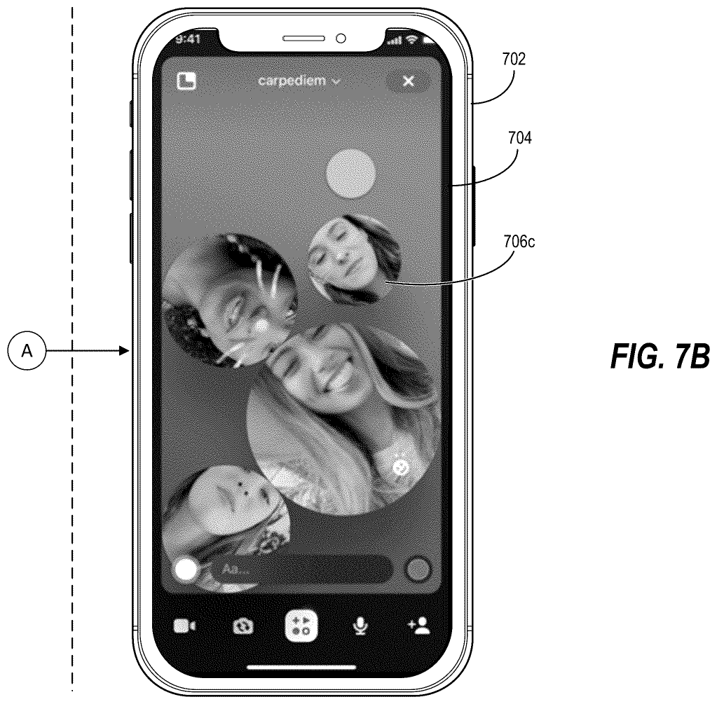

As shown in FIG. 4, the custom layout video call system 106 establishes a video call between video call participant device(s) 402 and a client device 414 through a video call streaming channel 404 (e.g., having a video data channel 406, an audio data channel 408, a video processing data channel 410, and a shared data channel 412). Moreover, as shown in FIG. 4, the client device 414 receives data from the video call participant device(s) 402 and renders video cells 418 within a customized video call interface 416. As shown in FIG. 4, the custom layout video call system 106 enables the client device 414 to render, within a self-view display format, modified video cells 418 that include modified visual properties and dynamic movement (e.g., circular video cells that include a bouncing effect). Although FIG. 4 illustrates a client device rendering a modified video cell with particular visual properties and dynamic movements, the custom layout video call system 106 can enable the client device to render a video cell with various visual properties and/or dynamic movement characteristics as described below (e.g., in relation to FIGS. 6A-6B and 7A-7B).

In one or more embodiments, the custom layout video call system 106 enables a client device to receive video data from participant devices during a video call to render modified (or customized) video cells. For example, the custom layout video call system 106 can enable the client device to modify various visual properties of a video cell. Indeed, the custom layout video call system 106 can enable the client device to modify visual properties to render the video cell with modified (or changed) visual characteristics within a custom video call interface.

In some cases, the custom layout video call system 106 enables the client device to modify a shape of a video cell (as a visual property) to render a customized video cell. For example, the client device can render a variously shaped video cells, such as, but not limited to a circular video cell, a triangular video cell, a star shaped video cell, a square shaped video cell, and/or an irregular shape video cell. Additionally, the custom layout video call system 106 can enable a client device to modify video cells such that the video cells have non-matching shapes (e.g., one video cell as a circle and another video cell as a triangle).

Moreover, the custom layout video call system 106 can enable the client device to modify a position of a video cell (as a visual property) to render a customized video cell. For instance, the client device can render video cells in various spatial positions, angles, and/or depths. To illustrate, the client device can render video cells in various spatial positions in the custom video call interface (e.g., using coordinates, ordered arrangements, regions). Moreover, the client device can render video cells in various angles (e.g., rotated 45 degrees, rotated 180 degrees). In addition, the custom layout video call system 106 can enable a client device to render video cells with various depths (e.g., modified z-coordinate values to bring forward and move behind other video cells, stacking or overlapping video cells).

Additionally, the custom layout video call system 106 can enable the client device to modify a size of a video cell (as a visual property) to render a customized video cell. For example, the client device can render video cells in various sizes (e.g., various sizes by pixel radius, length, and/or width). In some cases, the client device can render video cells with varying sizes such that the video cells (on a video call) have non-matching sizes (e.g., a large video cell and a small video cell).

Moreover, as mentioned above, the custom layout video call system 106 can enable a client device to render a video cell with dynamic movement. In particular, the client device can dynamically move a video cell such that the video cell emulates realistic and/or animated movements. As an example, the client device can render a video cell to have dynamic movement, such as, but not limited to bouncing movements, falling movements, accelerating movements, colliding movements, sliding movements, rolling movements, contracting movements, and/or expanding movements.

In some cases, the custom layout video call system 106 can enable a client device to dynamically move video cells by applying (or modifying) movement properties to the video cells for the dynamic movements. For example, the client device can apply or modify movement properties that correspond to various movement characteristics of a graphical object on the video cell. In some implementations, the custom layout video call system 106 enables a client device to apply or modify movement properties utilized by computer graphic-based physics engines to emulate movement (and other characteristics) in a graphical object (e.g., a video cell).

As an example, the client device can apply or modify movement properties such as gravity values (e.g., acceleration values associated with the video cell to emulate physics of falling on the video cell), mass values (e.g., values that assign a mass to a video cell such that a video cell is perceived to have a weight or density), and/or friction values (e.g., values or coefficients to modify an emulated amount of friction on a surface or boundary of the video cell). In some cases, the client device can apply or modify a collision boundary for the video cell (e.g., a collider object) such that the video cell frame or boundary detects collision or interaction with other graphical objects (e.g., other AR effects, video cells, or boundaries of a video call interface) during a video call. Moreover, the client device can apply or modify an elasticity value for the video cell such that the video cell frame contracts or expands at various speeds, durations, and/or lengths.

In one or more embodiments, the custom layout video call system 106 can enable a client device to modify a video (e.g., captured on the client device and/or received from a participant device) to fit a modified video cell. For example, the client device can modify a video by resizing the video to fit the modified video cell. In particular, in some cases, the client device can crop the video, resize the video (e.g., rescale), and/or modify a shape of the video to fit the modified video cell (e.g., a modified video cell with varying shapes, sizes, and/or positions). In some cases, the custom layout video call system 106 can enable a client device to track a face portrayed within a video to resize and/or crop the video while keeping the portrayed face centered (e.g., using face tracking data).

In some cases, the custom layout video call system 106 can enable a client device to utilize video processing data (e.g., captured on the client device and/or received from a participant device) to fit a video within a modified video cell. For example, the custom layout video call system 106 can enable a client device to utilize video processing data of a video to render a video texture from the video. Then, the client device can fit the video texture within the modified video cell. In some cases, the custom layout video call system 106 enables the client device to utilize video processing data (e.g., face tracking data, segmentation data) provided from other participant devices via split video frames and/or a separate video processing data channel as described in Blackburne.

In some implementations, the custom layout video call system 106 enables a client device to share video cell visual properties and/or dynamic movements of the video cell with other participant devices during the video call. In particular, the client device can share the video cell visual properties and/or dynamic movements of the video cell such that each participant device (locally) renders a shared custom video call interface with the synchronized (or similar) video cell modifications (e.g., to share the visual changes and movement across devices) during the video call. In some cases, the custom layout video call system 106 can enable a client device to share the video cell visual properties and/or dynamic movements (e.g., via movement properties) to participant client devices via the shared data channel (e.g., a data channel as described by Sherman).

Furthermore, the custom layout video call system 106 can enable the client device to render modified video cells of multiple participants within a self-view display. In particular, the client device can render and present the videos within modified video cells to present the multiple captured videos in an interface that is similar to the videos all being captured by the client device (e.g., not in a grid-view display). For example, rather than presenting a rendering of video captures from other client devices in a grid view, the video streams are, instead, received through a camera capture buffer (or a processing engine that processes video on the client device for the video call) (e.g., similar to the process for videos captured on the client device). Then, the client device can render the videos utilizing the corresponding video processing data (or video modifications) of the videos in a self-view display format.

In some cases, the custom layout video call system 106 can enable a client device to render modified video cells for multiple participants identified in a single video data stream (e.g., from a single client device). For example, a client device can capture multiple participants during a video call (e.g., two or more persons using the same client device for the video call). The custom layout video call system 106 can enable the client device to render a modified video cell for each of the multiple participants (e.g., separately render videos of each participant as separate modified video cells).

For example, the client device can determine more than one participant (e.g., person) is captured in a video stream. Then, the client device can render a first portion of the video stream as a first modified video cell to depict a first participant. In addition, the client device can render a second portion of the video stream as a second modified video cell to depict a second participant. Indeed, the custom layout video call system 106 can enable client device to render video cells for various numbers of participants present in a single video stream.

Additionally, the client device can transmit the video data (and/or video processing data) for each portrayed participant to other client devices on a video call. In some instances, the client device generates a separate video stream for each participant (e.g., cropping a video to focus on a specific participant) and/or corresponding video processing data for transmission to other client devices during a video call. Upon receiving video processing data that indicates multiple participants, a receiving client device can utilize the received video data (and/or video processing data) to separately render videos of each participant as separate modified video cells (e.g., as described in Blackburne).

In some implementations, the client device can assign each identified participant (or participant device) to a video cell slot. In one or more embodiments, the custom layout video call system 106 enables the client device (and other client devices on the video call) to include an N number of video cell slots assignable to individual participants (or participant devices). Moreover, the client device can maintain one or more null (open) video cell slots until a new participant is detected during the video call and can assign the newly detected participant to an open video cell slot. In some instances, the client device generates a new video cell slot when a new participant is detected during the video call. In one or more embodiments, the client device identifies and tracks a participant for a video cell slot utilizing a participant identifier (e.g., a participant name, user ID, tag, or other participant metadata) assigned to the participant.

Additionally, in one or more embodiments, the client device removes or assigns a null value to a video cell slot when a participant exits a video call. In some cases, the client device can reassign the null video cell slot to a new participant detected during a video call or the same participant when the participant reenters the video call. Indeed, the custom layout video call system 106 can enable client devices (during a video call) to render modified video cells for various numbers of participants.

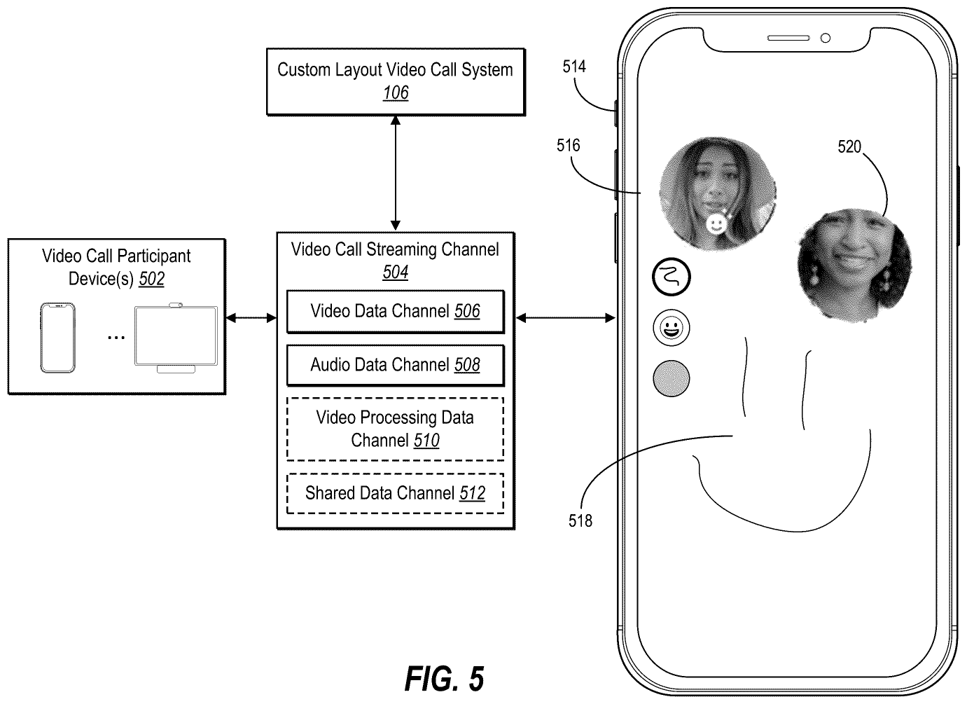

As mentioned above, the custom layout video call system 106 can enable a client device to render interactive objects within custom video interfaces. In one or more embodiments, the custom layout video call system 106 causes a client device to render an interactive object in a custom video interface having modified video cells. For instance, FIG. 5 illustrates the custom layout video call system 106 enabling a client device to render an interactive object within a custom video interface having modified video cells.

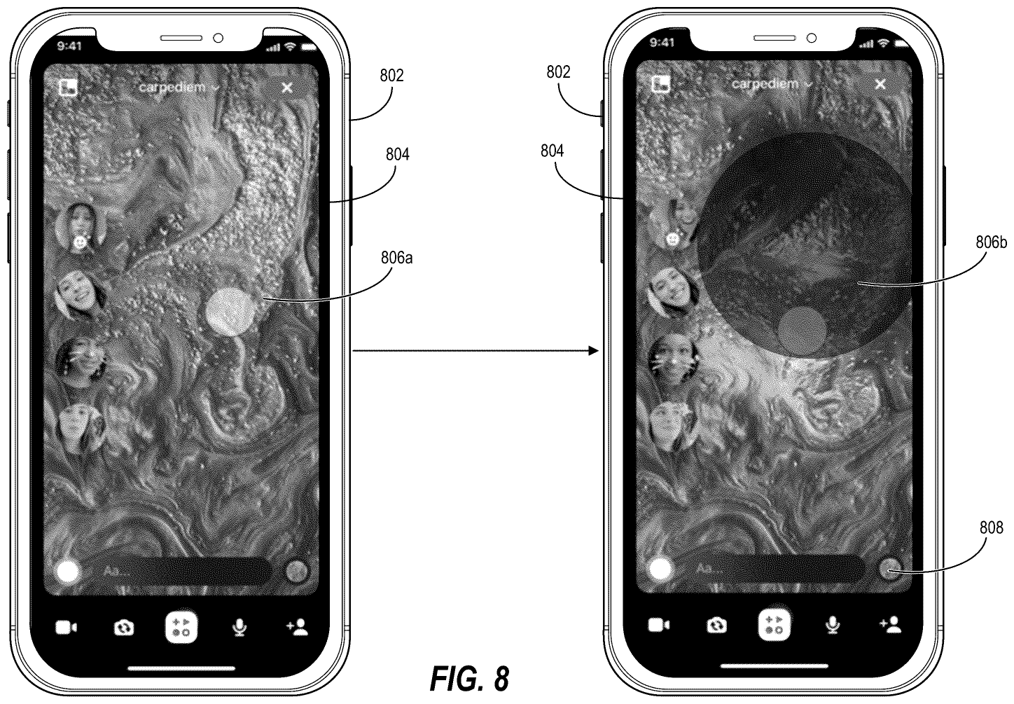

As shown in FIG. 5, the custom layout video call system 106 establishes a video call between video call participant device(s) 502 and a client device 514 through a video call streaming channel 504 (e.g., having a video data channel 506, an audio data channel 508, a video processing data channel 510, and a shared data channel 512). Moreover, as shown in FIG. 5, the client device 514 receives data from the video call participant device(s) 502 and renders video cells 520 within a customized video call interface 516. In addition, as illustrated in FIG. 5, the client device 514 also renders an interactive object 518 (e.g., an electronic drawing application) within the customized video call interface 516. As shown in FIG. 5, the client device(s), via user interactions, receive user interactions with the interactive object 518 and update the interactive object 518 (e.g., drawing within the electronic canvas rendered in the customized video call interface 516) during a video call. Although FIG. 5 illustrates a client device rendering an electronic drawing application as an interactive object, the custom layout video call system 106 can enable the client device to render various interactive objects as described below (e.g., in relation to FIGS. 8-16).

In one or more embodiments, the custom layout video call system 106 enables a client device to render an interactive object and updates to the interactive object. In some cases, the client device also transmits (and/or receives) user interactions and/or changes to the interactive object from other participant devices (e.g., via the shared data channel). Indeed, the custom layout video call system 106 can enable multiple client devices to render and share a synchronized interactive object during a video call such that participant users on the video call can interact with the same interactive object.

Additionally, the custom layout video call system 106 enables a client device to render an interactive object with effects. In one or more instances, the client device also transmits (and/or receives) effects for the interactive object from other participant devices (e.g., via the shared data channel). For example, the custom layout video call system 106 can enable multiple client devices to render and share synchronized (or same) effects for the interactive object during a video call (e.g., AR effects and/or other effects via the shared data channel). Indeed, in one or more embodiments, the custom layout video call system 106 can enable the client devices to transmit and receive interaction data and interactive object updates via a shared data channel as described in Sherman.

In some embodiments, the custom layout video call system 106 maintains a persistent interactive object between participants (or client devices of participants) between multiple video calls. For example, the custom layout video call system 106 can save (or remember) modifications or updates to an interactive object (e.g., drawings, paintings, music creation, video time stamp, video game progress) between the participant devices. Subsequently, upon receiving or initiating a video call via a participant device with the same participant devices, the custom layout video call system 106 can initiate the video call with a customized video interface to include various effects and modifications of the interactive objects from saved data (e.g., from historical video calls).

As mentioned above, the custom layout video call system 106 can enable a client device to render video cells in a custom video call interface upon receiving a user interaction requesting a custom video call interface. In some cases, the client device displays a menu interface with selectable options for video call interface customizations. For example, FIGS. 6A-6B illustrate the custom layout video call system 106 enabling a client device to receive a user interaction requesting a custom video call interface and rendering a custom video call interface with modified video cells.

As shown in FIG. 6A, the custom layout video call system 106 establishes a video call between a client device 602 and one or more other client devices. As shown in FIG. 6A, the client device 602 renders videos of video call participants within a grid-view display format 604. Furthermore, as illustrated in FIG. 6A, the client device 602 receives a user interaction with a selectable element 606 and displays a custom layout menu interface 608. Within the custom layout menu interface 608, the client device 602 receives a user interaction with a selectable element 610 indicating a selection of a custom video call interface layout (e.g., “floating”).

Subsequently, as shown in the transition from FIG. 6A to FIG. 6B, the client device 602 renders a custom video call interface 612 with a modified video cell 614a (in response to the selection of the selectable element 610). Indeed, as shown in FIG. 6B, the modified video cell 614a includes modified visual properties to change the shape, size, and position of the video cell. In addition, as shown in FIG. 6B, the client device 602 also modifies other video cells of other participants of the video call. Furthermore, as shown in FIG. 6B, upon receiving an additional user interaction (e.g., a swipe interaction, a touch interaction, a drag interaction, a device shake), the client device 602 further modifies the video cell 614b (from video cell 614a). Indeed, as shown in FIG. 6B, the client device 602 modifies the video cell 614b to have a different size and position compared to the video cell 614a. As further shown in FIG. 6B, the client device 602 also modifies other video cells of other participants of the video call (e.g., as part of the same user interaction and/or as part of separate user interactions).

In addition, as shown in FIG. 6B, the client device provides a selectable element 618 to introduce effects within the video call. For example, the client device can detect a user interaction with the selectable element 618 and, in response, provide for display, within the video call user interface, one or more selectable options to initiate an AR effect, interactive object, and/or other effect within the video call. Additionally, as shown in FIG. 6B, the client device also provides a selectable element 616 to modify backgrounds of the custom video call interface 612. Indeed, the client device can detect a user interaction with the selectable element 616 and, in response, modify a background color or other visual property of the custom video call interface 612.

As illustrated in FIGS. 6A-6B, the client device can receive user interactions with video cells and/or a custom video call interface to further modify (or update) video cells. For example, the custom layout video call system 106 can enable a client device to utilize various user interactions with the user interface (e.g., via touchscreen, mouse, keyboard, controller) and/or device movement. For example, the custom layout video call system 106 can enable a client device to utilize various user interactions, such as, but not limited to touching, dragging, tapping, swiping, clicking, device shaking, and/or device rotating.

Furthermore, as mentioned above, the custom layout video call system 106 can enable a client device to dynamically move video cells within a custom video interface. Indeed, a client device can dynamically move video cells to emulate movement effects, such as bouncing, colliding, sliding, falling, and/or stretching. For example, FIGS. 7A-7B illustrate the custom layout video call system 106 enabling a client device to dynamically move video cells within a custom video interface.

As shown in FIG. 7A, a client device 702 renders a video cell 706a (e.g., with a modified shape) in a custom video call interface 704. Additionally, the client device 702 renders the video cell 706a with one or more movement properties (as described above) such that the video cell 706a collides with other video cells, falls due to gravity, and bounces. To illustrate, the client device receives a user interaction (e.g., a drag and hold interaction) moving the video cell 706b away from the other video cells (e.g., upwards). Then, as shown in the transition from FIG. 7A to FIG. 7B, the client device 702 renders the video cell 706c dynamically moving down towards the other video cells and bouncing on the other video cells (e.g., falling and bouncing) upon receiving a user interaction to release the video cell 706c (e.g., releasing the drag and hold interaction).

As previously mentioned, the custom layout video call system 106 can enable a client device to receive and utilize various interactions to dynamically move video cells within a custom video call interface. For example, the client device can receive and utilize touching, dragging, tapping, tapping, and/or swiping interactions to dynamically move video cells. Furthermore, the client device can also receive and utilize phone movements (e.g., shaking, shuffling, rotating, flipping, flicking) to dynamically move video cells.

Although FIGS. 6A-B and 7A-7B illustrate specific video cell shapes (visual properties) and/or specific dynamic movements (e.g., via movement properties), the custom layout video call system 106 can enable a client device to render video cells with various video cell visual properties and various visual cell dynamic movements.

As also mentioned above, the custom layout video call system 106 can enable a client device to render a custom video call interface by rendering an interactive object during a video call. For example, the client device can render an interactive object in addition to modified video cells within a custom video call interface. Additionally, the client device can introduce various interactive objects, such as graphical materials and/or interactive applications within the custom video call interface. In some implementations, the custom layout video call system 106 enables client devices participating in a video call to share interactive objects across the multiple client devices (as described above).

In some implementations, the custom layout video call system 106 enables a client device to render a graphical material as an interactive object during a video call. For example, FIG. 8 illustrates a custom layout video call system 106 enabling a client device to render a material as an interactive object during a video call. Indeed, as shown in FIG. 8, the custom layout video call system 106 establishes a video call between a client device 802 and one or more other participant client devices. As further shown in FIG. 8, the client device 802 renders a material 806a (e.g., a slime material) within a custom video call interface 804. In addition to the material 806a, the client device 802 also renders video cells of participants of the video call.

Moreover, in one or more embodiments, the custom layout video call system 106 enables a client device to render a material that dynamically moves (or visually changes) based on user interactions with the rendered material. For example, as shown in FIG. 8, upon detecting a user interaction within the client device 802 (e.g., a touch interaction) on the material 806a, the client device 802 renders the modified material 806b dynamically moving to form a crater in the modified material 806b. Indeed, the client device can render the material 806b to move and change visually based on user interactions detected on the one or more client devices participating in the video call.

In some embodiments, the client device renders the graphical material in various portions of the custom video call interface. For instance, the client device can render the graphical material as an entire background for the custom video call interface. In some embodiments, the client device can render the graphical material in one or more portions of the custom video call interface.

Additionally, the client device can render the material to emulate various dynamic movements upon detecting user interactions with the material. For example, the client device can render and dynamically move a material to emulate movement behaviors, such as, but not limited to, the material forming craters, the material bouncing, the material stretching, and/or the material tearing. In addition, the client device can modify visual properties of the material and/or dynamically move the material based on various detected user interactions, such as, but not limited to touch interactions, drag interactions, tap interactions, swipe interactions, click interactions, device shaking, and/or device rotation.

Additionally, the client device can modify colors and/or styles of a rendered material. For instance, as shown in FIG. 8, the client device provides, for display, a selectable element 808 to modify a color and/or style of a rendered material. Indeed, upon detecting an interaction with the selectable element 808, the client device can render a displayed material in a different color or a different style and/or render a different material within the custom video call interface 804.

Although one or more embodiments herein illustrate a client device rendering a slime-based material, the custom layout video call system 106 can enable a client device to render a variety of materials during a video call. For example, the client device can render materials, such as, but not limited to, cloth-based materials, rubber-based materials, water-based materials, and/or sand-based materials.

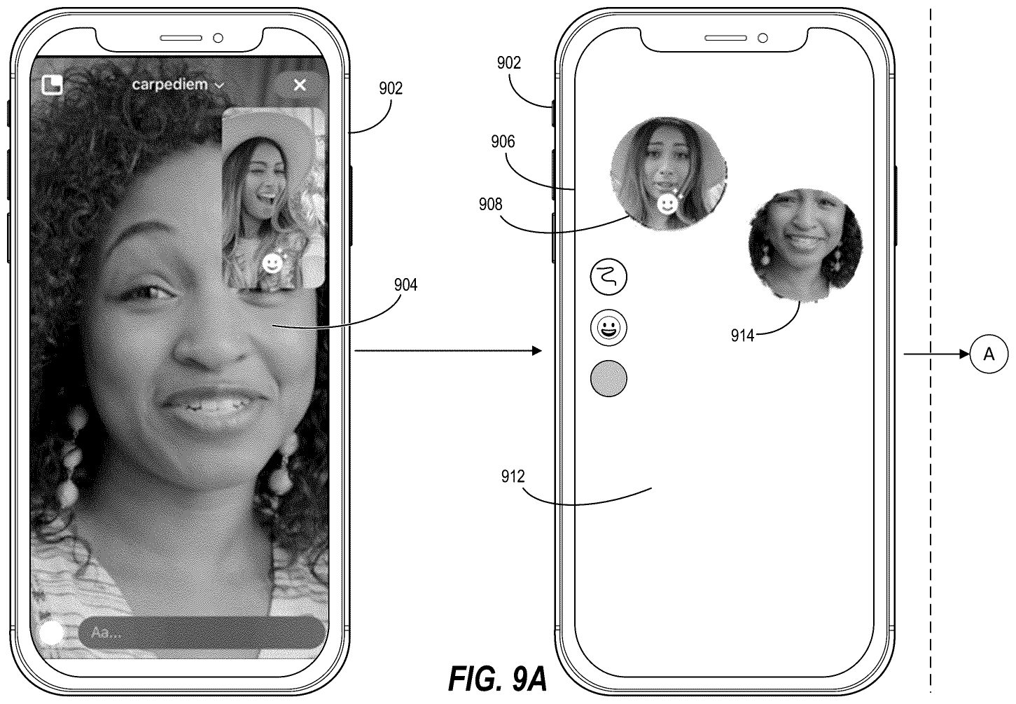

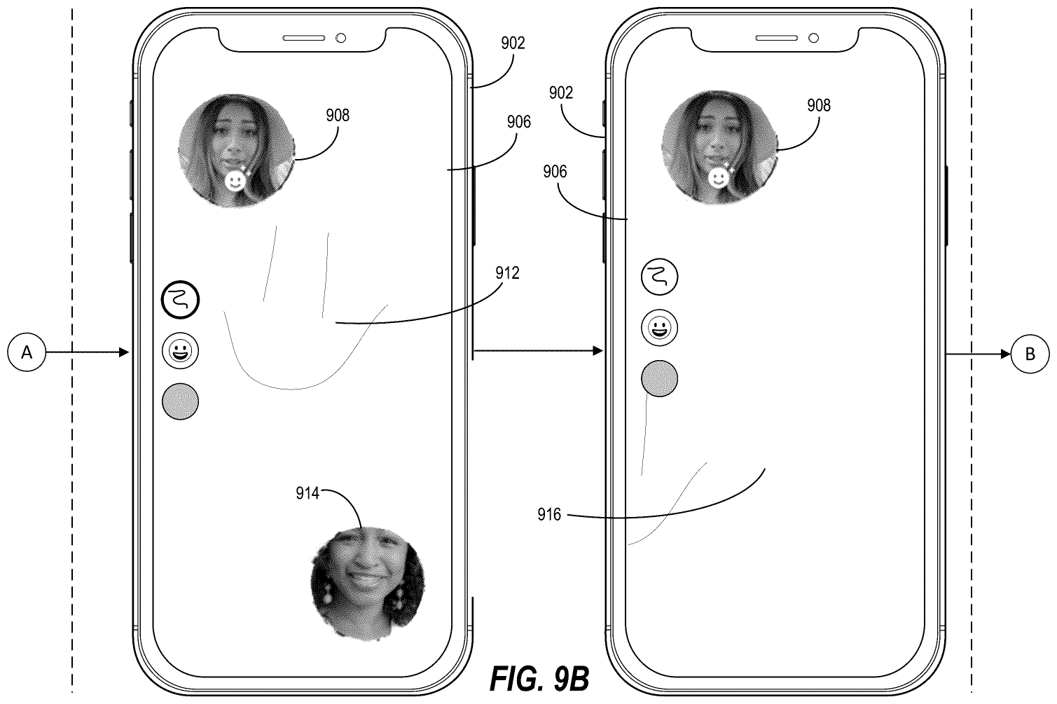

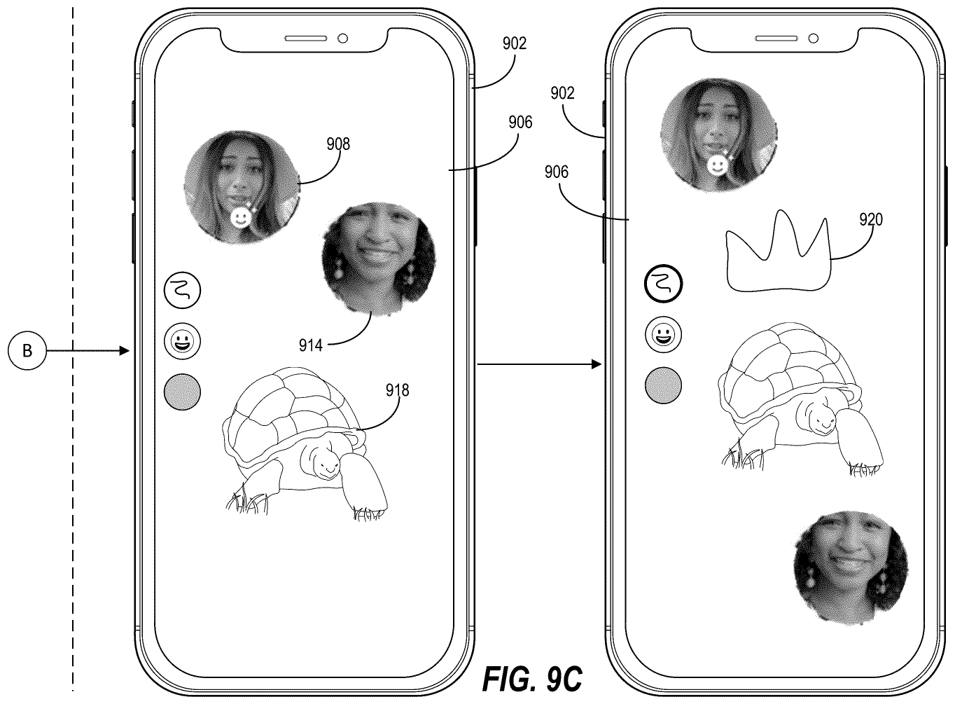

Furthermore, the custom layout video call system 106 can enable client devices to render custom video call interfaces with interactive applications (as interactive objects). For example, the custom layout video call system 106 can enable a client device to render various interactive applications that facilitate creation, viewing, and/or playing of content during a video call. As examples, FIGS. 9-16 illustrate a variety of interactive applications rendered by a client device during a video call.

For example, FIGS. 9A-9C illustrate a custom layout video call system 106 enabling an electronic drawing (or painting) application (e.g., a canvas application) during a video call between multiple participant users. As shown in FIG. 9A, the custom layout video call system 106 enables a client device 902 to establish a video call within a video call interface 904 (e.g., a grid-view display format). Upon receiving a user interaction requesting to initiate a custom video call interface with an electronic drawing application, the client device 902 renders a custom video call interface 906 with modified video cells 908, 914 and an electronic drawing area 912 (e.g., an electronic canvas).

As shown in the transition from FIG. 9A to FIG. 9B, the custom layout video call system 106 can enable a client device to receive user interactions from the participant users operating the client devices (with various drawing functions) on the video call in the electronic drawing area 912 (e.g., an interactive object) to update the electronic drawing area 912 (e.g., with a first drawing). As further shown in FIG. 9B, the client device 902 also dynamically moves video cells 908, 914 to be adjacent to the electronic drawing area 912 such that the drawing is not obstructed. In addition, the client device can provide various functions within the electronic drawing application, such as, but not limited to varying drawing shapes, pencil tools, pen tools, paint tools, fill tools, crop tools, image insertion tools, video insertion tools, sticker insertion tools, text insertion tools, and/or color application tools.

Additionally, FIG. 9B also illustrates the client device 902 rendering the video cell 908 moving to an additional electronic drawing area 916 within the custom video call interface 906. In particular, the client device (and other participant client devices) can receive user interactions that navigate a participant user to other portions of an interactive object (e.g., the electronic canvas). Upon receiving the user interactions to navigate to another portion, the client device 902 renders the video cell that corresponds to the client device 902 (e.g., the video cell 908) at a position of the navigation. In addition, the client device 902 can also receive interaction updates of other participant users from other participant client devices (as described above) and utilize the data to render the video cell corresponding to the other participant client device (e.g., the video cell 914) at a position of the other participant user's navigation.

Moreover, as shown in the transition from FIG. 9B to FIG. 9C, the custom layout video call system 106 can enable the client device to render the video cell 908 moving to a third electronic drawing area 918 within the electronic canvas of the custom video call interface 906 at which the participant user (e.g., corresponding to the video cell 914) is positioned and interacting with the electronic canvas. Indeed, the client device 902 further detects additional user interactions from one or more of the participant client devices during the video call to render additional content 920 within the custom video call interface 906.

Although one or more embodiments herein illustrate a client device facilitating a drawing application within a custom video call interface, the custom layout video call system 106 can enable a client device to render interactive objects for various content creation applications. For example, the custom layout video call system 106 can enable a client device to render an interactive object to paint during a video call. In addition, the custom layout video call system 106 can enable a client device to render an interactive object to edit images and/or video (e.g., via an image editing application and/or video editing application) during a video call. Moreover, the custom layout video call system 106 can enable a client device to render an interactive object to read and/or edit electronic documents (e.g., text documents, slide documents, spreadsheet documents).

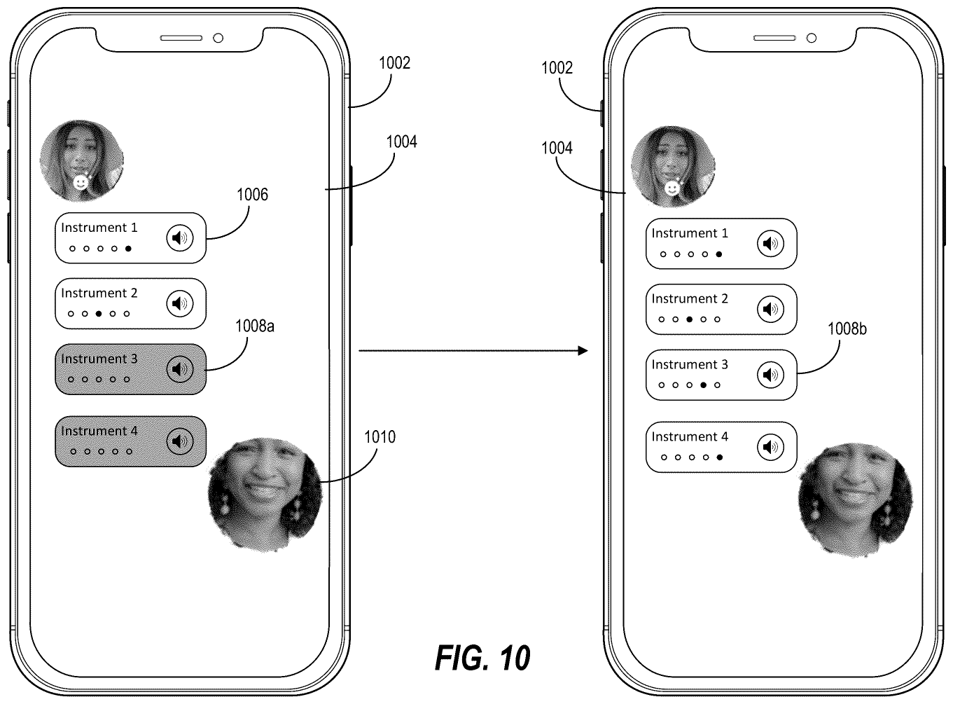

As another example of the custom layout video call system 106 enabling a client device to render an interactive object for content creation, FIG. 10 illustrates a client device rendering a music development application during a video call. For instance, as shown in FIG. 10, the client device 1002 renders, during a video call, a custom video call interface 1004 having active sound instruments 1006 and inactive sound instruments 1008a in addition to video cells 1010. In one or more embodiments and as shown in FIG. 10, the client device 1002 detects a user interaction with the inactive sound instrument 1008a and enables the sound instrument (as inactive sound instrument 1008b). Indeed, the custom layout video call system 106 can enable a client device to receive interactions from users (via client devices participating on the video call) to create and/or modify music via selectable instrument options to create different sounds.

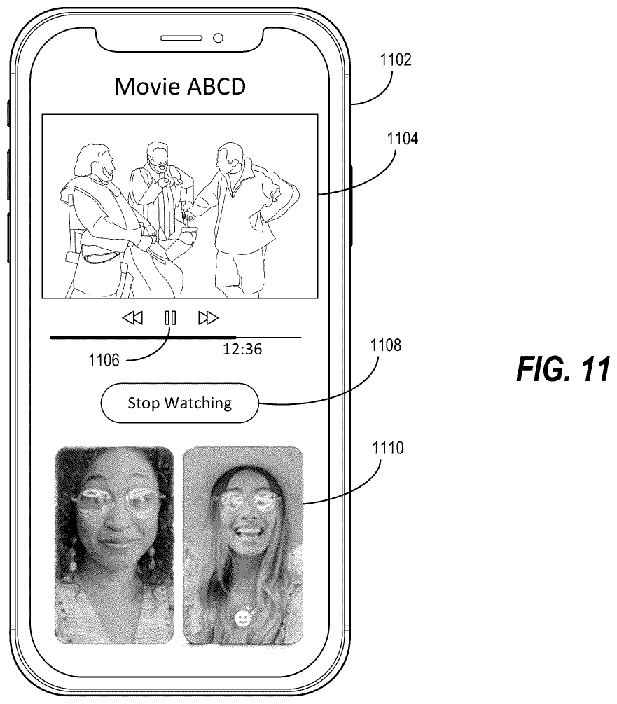

Furthermore, the custom layout video call system 106 can enable a client device to render a custom video call interface with media streaming content as the interactive object. For example, FIG. 11 illustrates the custom layout video call system 106 enabling a client device to render a custom video call interface with media streaming content during a video call. As shown in FIG. 11, the client device 1102 can render an interactive object 1104 (e.g., a video stream player) during a video call that includes video cells 1110. Indeed, the custom layout video call system 106 can enable participant client devices to render a media content stream that is played and viewed while also conducting the video call between the participant users corresponding to the video cells 1110. Although FIG. 11 illustrates a video stream as media streaming content, the client device can render various streaming content, such as, but not limited to a music stream, a live online stream, a slide show presentation, and/or a video game stream.

Additionally, as shown in FIG. 11, the client device 1102 renders selectable elements 1106 to interact with the interactive object 1104. As shown in FIG. 11, the client device 1102 renders the selectable elements 1106, 1108 to modify the playback of the video stream (e.g., the interactive object 1104). For example, the client device can detect user interactions to pause, stop, track back, and/or track forward the video stream displayed during the video call. Indeed, in one or more embodiments, the interactions with the selectable elements 1106, 1108 modify the playback of the video stream locally (on the client device 1102) and on the other participant client devices of the video call (e.g., utilizing shared data channels as described above).

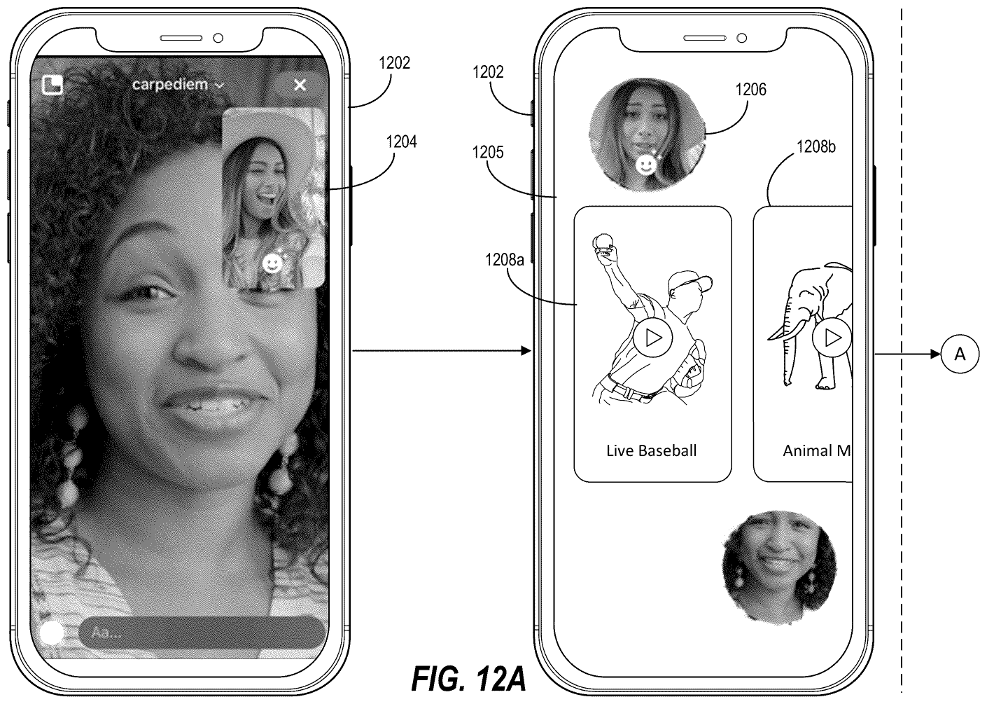

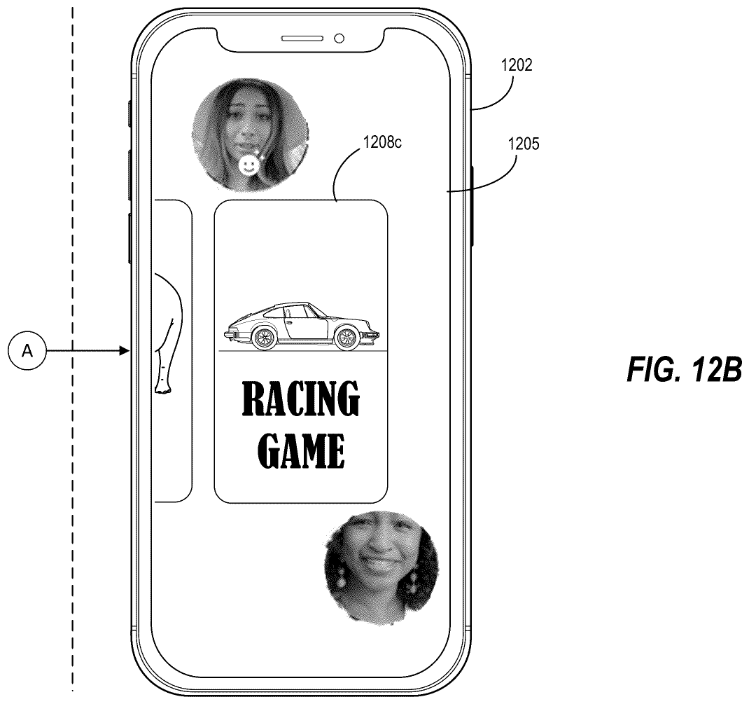

In some embodiments, the custom layout video call system 106 enables a client device to render a media library browsing application as an interactive object during a video call (within a custom video call interface). For instance, FIGS. 12A-12B illustrate a custom layout video call system 106 enabling a client device to render a media library browsing application during a video call. For instance, as shown in FIG. 12A, the custom layout video call system 106 establishes a video call between a client device 1202 and another client device. Indeed, as shown in FIG. 12A, the client device 1202 renders a video call interface 1204 (e.g., a grid-view display). Upon detection (or receiving) a user interaction to access a media library, the client device 1202 renders a media library browsing application 1205 with modified video cells 1206 during the video call. Indeed, the client device renders selectable media content items 1208a, 1208b within the media library browsing application 1205 during the video call.

Additionally, as shown in the transition from FIG. 12A to FIG. 12B, the client device 1202 renders additional selectable media content item 1208c (e.g., a video game) upon detecting a user interaction to navigate between media content items (e.g., from a user corresponding to the client device 1202 or a user participating on the video call from another client device). Although FIGS. 12A and 12B illustrate the client device 1202 rendering a media library browsing application during a video call, the custom layout video call system 106 can enable the client device 1202 to render various browsing applications. For example, the custom layout video call system 106 can enable a client device to render a browsing application, such as, but not limited to browsing mobile applications, web browser tabs, and/or images (e.g., an electronic album).

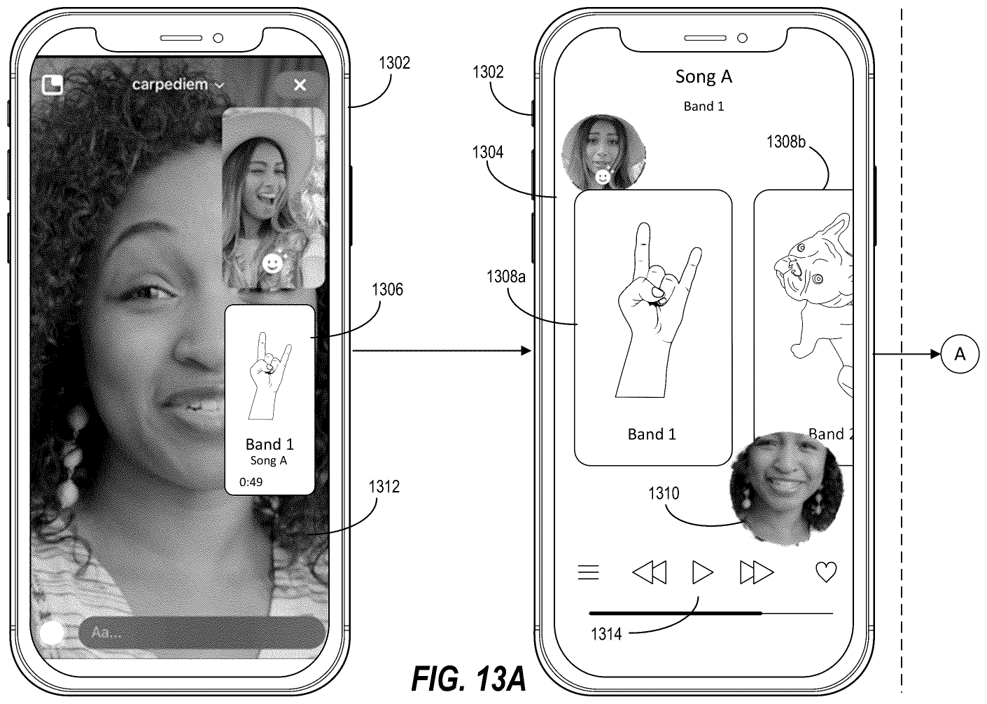

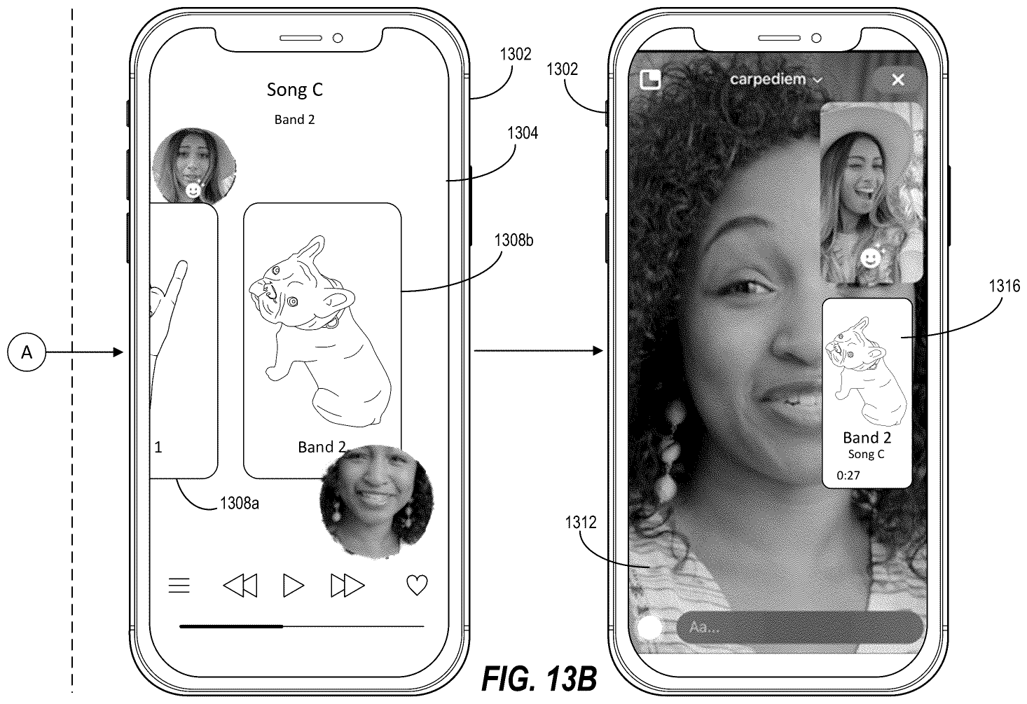

In some embodiments, the custom layout video call system 106 can enable a client device to render an interactive object to stream music during a video call. For example, FIGS. 13A-13B illustrate a custom layout video call system 106 enabling a client device to render a widget as an interactive object to stream music and also browse music content during a video call. For example, as shown in FIG. 13A, the custom layout video call system 106 establishes a video call between a client device 1302 and another client device within a custom video call interface 1312. Additionally, as shown in FIG. 13A, the client device 1302 renders a widget 1306 (as an interactive object) to display and stream music (e.g., “Song A”).

Furthermore, as shown in FIG. 13A, upon detecting a user interaction with the widget 1306 (e.g., by a user of the client device 1302 and/or a participant user on a participant client device), the client device 1302 renders an interactive object to browse music in a custom video call interface 1304 with video cells 1310. As shown in FIG. 13A, the client device 1302 renders selectable media content items 1308a, 1308b within the custom video call interface 1304. Moreover, as shown in FIG. 13A, the client device 1302 also renders playback options 1314 for the music stream during the video call.

Moreover, as shown in the transition from FIG. 13A to FIG. 13B, the client device 1302 navigates between the selectable media content item 1308a and 1308b upon detecting a user interaction to navigate between the media content items (e.g., from a user corresponding to the client device 1302 or a user participating on the video call from another client device). Moreover, as shown in FIG. 13B, upon detecting a selection of the selectable media content item 1308b, the client device 1302 renders the custom video call interface 1312 with a widget 1316 for the newly selected music stream.

Although FIGS. 13A-13B illustrate a client device rendering a widget for music streams, the custom layout video call system 106 can enable a client device to render widgets within a custom video call interface for various functions. For example, the client device can render a widget to display various applications, such as, but not limited to a weather application, a stock market application, an email application, a calculator application, and/or a calendar application during a video call.

Additionally, in some implementations, the custom layout video call system 106 enables client devices to render video cells in a custom video interface by placing video cells in a graphical environment during the video call. For example, the custom layout video call system 106 can enable a client device to position video cells within an environment with graphical elements that represent a theme. For example, the client device can render video cells positioned within graphical environments, such as, but not limited to geographical locations and/or places (e.g., a stadium, living room, kitchen, swimming pool).

Moreover, the client device can render the video cells (of a video call) within a graphical environment while also rendering one or more additional interactive objects within the graphical environment. For instance, the client device can render a custom video call interface with the video cells and an interactive object in a graphical environment (e.g., streaming a movie in a living room environment, listening to music in a swimming pool environment, playing a mobile game in a graphical spaceship environment).

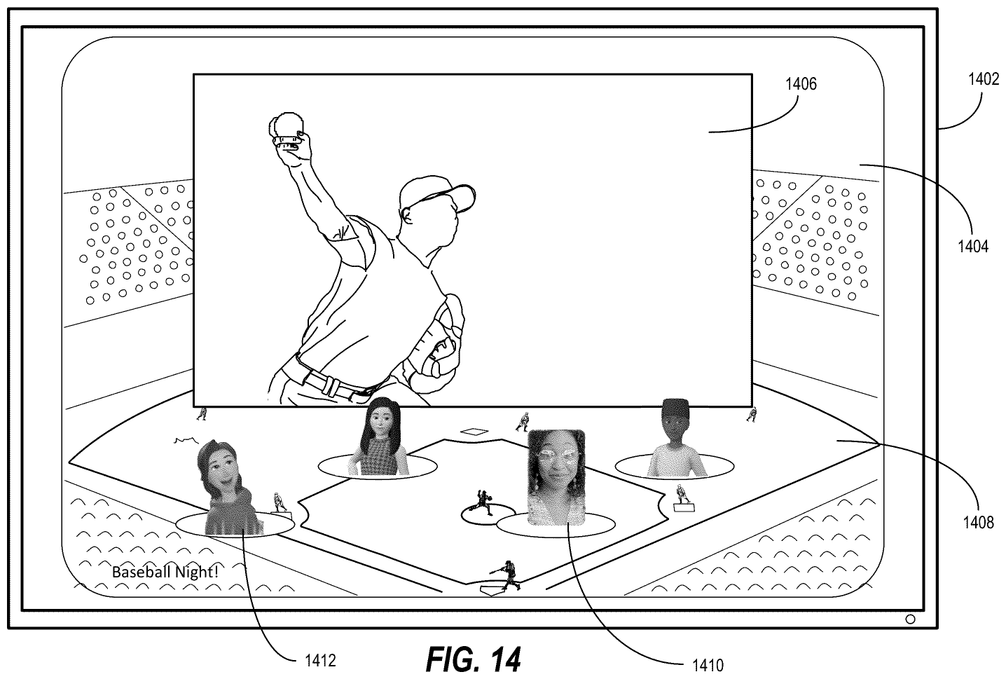

As an example, FIG. 14 illustrates the custom layout video call system 106 enabling a client device to render video cells and an interactive object within a graphical environment (as the custom video call interface). For instance, as shown in FIG. 14, the custom layout video call system 106 establishes a video call between a client device 1402 and one or more other client devices. Moreover, the client device 1402 renders video cells 1412, 1410 placed within a graphical environment 1408 (e.g., a stadium) of the custom video call interface 1404. Additionally, as shown in FIG. 14, the client device 1402 also renders an interactive object 1406 to stream media content (e.g., a live baseball game) during the video call.

In one or more embodiments and as shown in FIG. 14, the custom layout video call system 106 enables a client device to render captured video data during a video call using various types of participant representations. For instance, as shown in FIG. 14, the client device 1402 renders a video cell 1410 to fit within the graphical environment 1408. Moreover, the client device 1402 also renders a video cell 1412 as an avatar representing a participant user (and movements of the participant user captured on video). In some instances, the client device utilizes video processing data to render video data of a participant as an avatar, animation, hologram, or other effect (e.g., as described in Blackburne).

In some implementations, the custom layout video call system 106 enables a client device to render a custom video call interface with an interactive object that executes a video game during the video call. For instance, the custom layout video call system 106 can cause a client device to launch (as an interactive object within the custom video call interface), a video game application. Indeed, the custom layout video call system 106 can enable client devices participating in the video call to detect interactions with the video game application and update graphical elements for the video game application (on each of the participant client devices). For example, the client devices can, during the video call, receive and/or transmit updates to graphical elements, scores, positions, and/or other video game properties or elements during a video call (e.g., utilizing a shared data channel as described by Sherman).

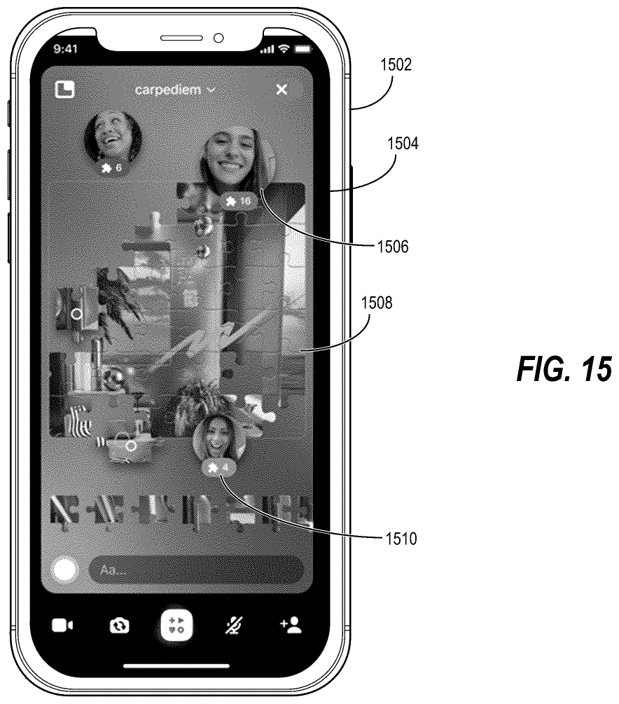

For example, FIG. 15 illustrates the custom layout video call system 106 enabling a client device to render a video game application as an interactive object within a custom video call interface. As shown in FIG. 15, the custom layout video call system 106 establishes a video call between the client device 1502 and one or more other client devices. Subsequently, as shown in FIG. 15, the client device 1502 renders a video game application 1508 with video cells 1506 in a custom video call interface 1504. As further shown in FIG. 15, the client device 1502 also renders scores 1510 corresponding to participant users with the video cells of the video call. The client device 1502 can during the video call, receive and/or transmit updates to graphical elements, scores, positions, and/or other video game properties or elements of the video game application 1508 from (or to) one or more other participant client devices during the video call.

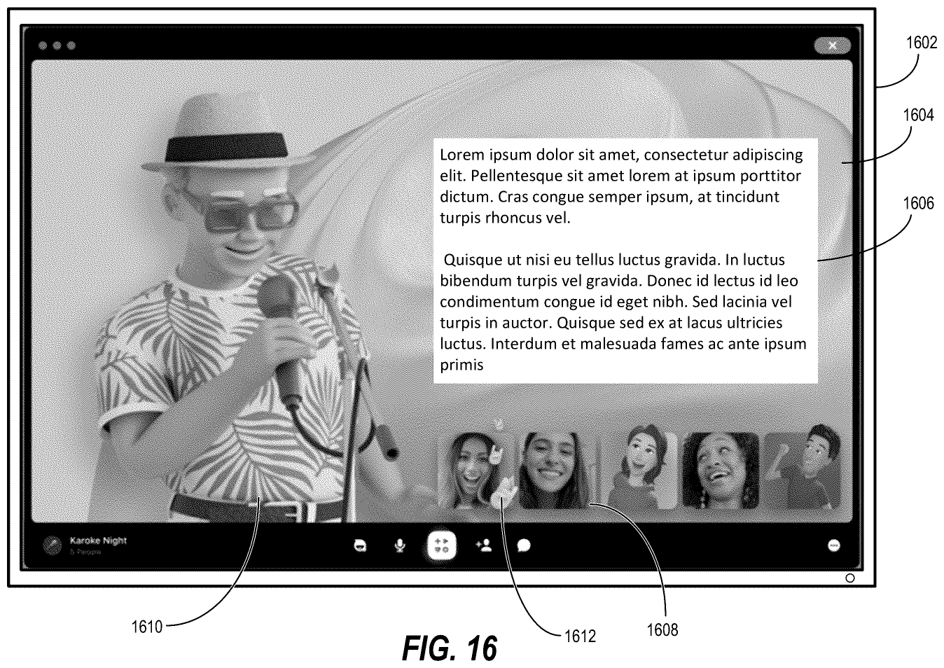

As another example, the custom layout video call system 106 can enable client devices participating in a video call to render a karaoke application as an interactive object. For example, FIG. 16 illustrates the custom layout video call system 106 enabling a client device to render a karaoke application with video cells during a video call. As shown in FIG. 16, the custom layout video call system 106 establishes a video call between a client device 1602 and one or more other client devices. Moreover, the client device 1602 renders various video cells 1610, 1608 (e.g., having different visuals, shapes, sizes) within the custom video call interface 1604. Additionally, the client device 1602 renders a karaoke lyrics element 1606 during the video call (as an interactive object). Moreover, as shown in FIG. 16, the client device 1602 receives user feedback from other participant client devices and renders visual effects 1612 for the user feedback during the video call.

Additionally, in some cases, the custom layout video call system 106 enables a client device to render a custom video call interface by overlaying video cells over a third-party application. For instance, the client device can execute and/or run a third-party application while also executing a video call. Indeed, the client device can render video cells (e.g., modified video cells) as overlay objects on the third-party application (e.g., enabling a user to browse a web browser while viewing video cells of a video call).

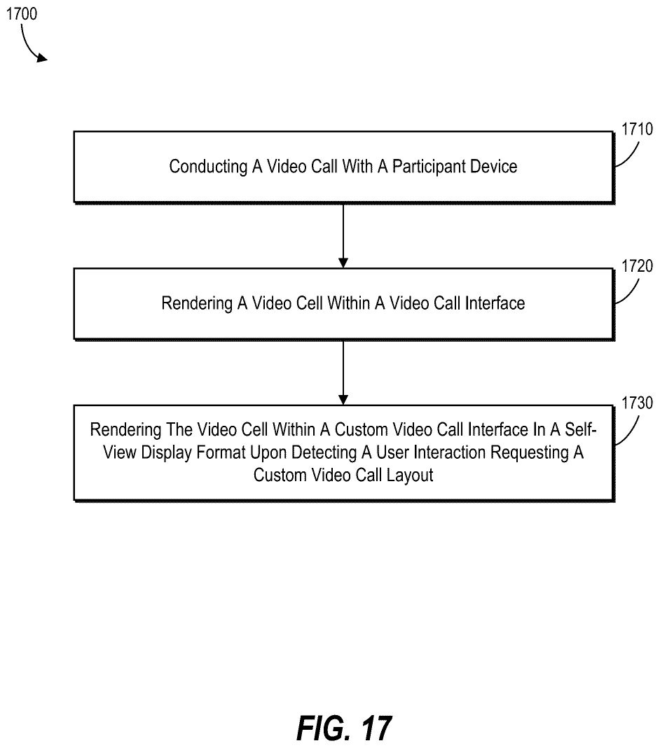

FIGS. 1-16, the corresponding text, and the examples provide a number of different methods, systems, devices, and non-transitory computer-readable media of the custom layout video call system 106. In addition to the foregoing, one or more embodiments can also be described in terms of flowcharts comprising acts for accomplishing particular results, as shown in FIG. 17. FIG. 17 may be performed with more or fewer acts. Furthermore, the acts shown in FIG. 17 may be performed in different orders. Additionally, the acts described in FIG. 17 may be repeated or performed in parallel with one another or in parallel with different instances of the same or similar acts.

For example, FIG. 17 illustrates a flowchart of a series of acts 1700 for rendering video cells in custom video call interfaces in accordance with one or more implementations. While FIG. 17 illustrates acts according to one or more embodiments, alternative embodiments may omit, add to, reorder, and/or modify any of the acts shown in FIG. 17. In some implementations, the acts of FIG. 17 are performed as part of a method. Alternatively, a non-transitory computer-readable medium can store instructions thereon that, when executed by at least one processor, cause a computing device to perform the acts of FIG. 17. In some embodiments, a system performs the acts of FIG. 17. For example, in one or more embodiments, a system includes at least one processor. The system can further include a non-transitory computer-readable medium comprising instructions that, when executed by the at least one processor, cause the system to perform the acts of FIG. 17.

As shown in FIG. 17, the series of acts 1700 includes an act 1710 of conducting a video call with a participant device. For example, the act 1710 can include conducting (by a client device) a video call with a participant device through a streaming channel established for the video call from the participant device. In some instances, the act 1710 includes establishing a streaming channel that includes a video data channel, an audio data channel, a shared data channel (e.g., an AR data channel), and/or a video processing data channel.

As further shown in FIG. 17, the series of acts 1700 includes an act 1720 of rendering a video cell within a video call interface. In particular, the act 1720 can include rendering, within a video call interface displayed on a client device, a video cell portraying a video utilizing video data received from a participant device in a grid-view display format. Additionally, the act 1720 can include rendering (or displaying), within a video call interface, a selectable element (or option) to request a display of a custom video call interface.

Furthermore, as shown in FIG. 17, the series of acts 1700 includes an act 1730 of rendering a video cell within a custom video call interface in a self-view display format (on a client device) upon detecting a user interaction requesting (or indicating a request to display) a custom video call layout. Moreover, the act 1730 can include, upon detecting a user interaction indicating a request to display a custom video call interface layout, rendering an additional video cell portraying an additional video utilizing additional video data captured by a client device within the custom video call interface in a self-view display format.

For example, the act 1730 can include rendering a video cell within a custom video call interface by modifying a visual property of the video cell based on the custom video call interface. Additionally, the act 1730 can include modifying a visual property of a video cell (based on detecting a user interaction with a video cell or a custom video call interface). For instance, in the act 1730, modifying a visual property of a video cell can include changing a size, a shape, or a position of the video cell. In some cases, the act 1730 can include modifying a video from video data to fit a modified visual property of a video cell. Moreover, the act 1730 can include generating a video texture from a video utilizing video data received from a participant device and fitting the video texture within a modified video cell. In one or more embodiments, the act 1730 includes rendering a custom video call interface in a self-view display format to render a video cell of a video corresponding to a participant device via a camera buffer view of a client device.

Moreover, the act 1730 can include rendering a video cell within a custom video call interface by dynamically moving the video cell within the custom video call interface during the video call. In some implementations, the act 1730 includes rendering a video cell within a custom video call interface by applying a movement property to a video cell (based on a custom video call interface or detecting a user interaction with a video cell). For example, a movement property can include a mass value, a collision boundary, a gravity value, a friction value, and/or an elasticity value corresponding to a video cell.

Additionally, the act 1730 can include rendering a custom video call interface by rendering an interactive object within the custom video call interface. Moreover, the act 1730 can include updating an interactive object upon receiving a user interaction corresponding to the interactive object. In some cases, the act 1730 can include updating an interactive object upon receiving a user interaction corresponding to the interactive object from a participant device through a streaming channel. For example, a streaming channel can include a video data channel and a shared data channel. For instance, an interactive object can include a material and/or an interactive application. Furthermore, an interactive application can include an electronic paint application, an electronic document application, digital content streaming application, a video game application, a music development application, and/or a media browsing library application.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., memory), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RANI and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed by a processor, cause a general-purpose computer, special purpose computer, or special purpose processing device to perform a certain function or group of functions. In some embodiments, computer-executable instructions are executed by a general-purpose computer to turn the general-purpose computer into a special purpose computer implementing elements of the disclosure. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present disclosure can also be implemented in cloud computing environments. As used herein, the term “cloud computing” refers to a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In addition, as used herein, the term “cloud-computing environment” refers to an environment in which cloud computing is employed.

FIG. 18 illustrates a block diagram of an example computing device 1800 that may be configured to perform one or more of the processes described above. One will appreciate that one or more computing devices, such as the computing device 1800 may represent the computing devices described above (e.g., server device(s) 102 and/or a client devices 110a, 110b-110n). In one or more embodiments, the computing device 1800 may be a mobile device (e.g., a mobile telephone, a smartphone, a PDA, a tablet, a laptop, a camera, a tracker, a watch, a wearable device, a head mounted display, etc.). In some embodiments, the computing device 1800 may be a non-mobile device (e.g., a desktop computer or another type of client device). Further, the computing device 1800 may be a server device that includes cloud-based processing and storage capabilities.

As shown in FIG. 18, the computing device 1800 can include one or more processor(s) 1802, memory 1804, a storage device 1806, input/output interfaces 1808 (or “I/O interfaces 1808”), and a communication interface 1810, which may be communicatively coupled by way of a communication infrastructure (e.g., bus 1812). While the computing device 1800 is shown in FIG. 18, the components illustrated in FIG. 18 are not intended to be limiting. Additional or alternative components may be used in other embodiments. Furthermore, in certain embodiments, the computing device 1800 includes fewer components than those shown in FIG. 18. Components of the computing device 1800 shown in FIG. 18 will now be described in additional detail.

In particular embodiments, the processor(s) 1802 includes hardware for executing instructions, such as those making up a computer program. As an example, and not by way of limitation, to execute instructions, the processor(s) 1802 may retrieve (or fetch) the instructions from an internal register, an internal cache, memory 1804, or a storage device 1806 and decode and execute them.

The computing device 1800 includes memory 1804, which is coupled to the processor(s) 1802. The memory 1804 may be used for storing data, metadata, and programs for execution by the processor(s). The memory 1804 may include one or more of volatile and non-volatile memories, such as Random-Access Memory (“RAM”), Read-Only Memory (“ROM”), a solid-state disk (“SSD”), Flash, Phase Change Memory (“PCM”), or other types of data storage. The memory 1804 may be internal or distributed memory.

The computing device 1800 includes a storage device 1806 includes storage for storing data or instructions. As an example, and not by way of limitation, the storage device 1806 can include a non-transitory storage medium described above. The storage device 1806 may include a hard disk drive (HDD), flash memory, a Universal Serial Bus (USB) drive or a combination these or other storage devices.

As shown, the computing device 1800 includes one or more I/O interfaces 1808, which are provided to allow a user to provide input to (such as user strokes), receive output from, and otherwise transfer data to and from the computing device 1800. These I/O interfaces 1808 may include a mouse, keypad or a keyboard, a touch screen, camera, optical scanner, network interface, modem, other known I/O devices or a combination of such I/O interfaces 1808. The touch screen may be activated with a stylus or a finger.

The I/O interfaces 1808 may include one or more devices for presenting output to a user, including, but not limited to, a graphics engine, a display (e.g., a display screen), one or more output drivers (e.g., display drivers), one or more audio speakers, and one or more audio drivers. In certain embodiments, I/O interfaces 1808 are configured to provide graphical data to a display for presentation to a user. The graphical data may be representative of one or more graphical user interfaces and/or any other graphical content as may serve a particular implementation.

The computing device 1800 can further include a communication interface 1810. The communication interface 1810 can include hardware, software, or both. The communication interface 1810 provides one or more interfaces for communication (such as, for example, packet-based communication) between the computing device and one or more other computing devices or one or more networks. As an example, and not by way of limitation, communication interface 1810 may include a network interface controller (NIC) or network adapter for communicating with an Ethernet or other wire-based network or a wireless NIC (WNIC) or wireless adapter for communicating with a wireless network, such as a WI-FI. The computing device 1800 can further include a bus 1812. The bus 1812 can include hardware, software, or both that connects components of computing device 1800 to each other. As an example, the bus 1812 may include one or more types of buses.

Embodiments of the invention may include or be implemented in conjunction with an artificial reality system. Artificial reality is a form of reality that has been adjusted in some manner before presentation to a user, which may include, e.g., a virtual reality (VR), an augmented reality (AR), a mixed reality (MR), a hybrid reality, or some combination and/or derivatives thereof. Artificial reality content may include completely generated content or generated content combined with captured content (e.g., real-world photographs). The artificial reality content may include video, audio, haptic feedback, or some combination thereof, and any of which may be presented in a single channel or in multiple channels (such as stereo video that produces a three-dimensional effect to the viewer). Additionally, in some embodiments, artificial reality may be associated with applications, products, accessories, services, or some combination thereof, that are, e.g., used to create content in an artificial reality and/or used in (e.g., perform activities in) an artificial reality. The artificial reality system that provides the artificial reality content may be implemented on various platforms, including a head-mounted display (HMD) connected to a host computer system, a standalone HMD, a mobile device or computing system, or any other hardware platform capable of providing artificial reality content to one or more viewers.

As mentioned above, the communications system can be included in a social networking system. A social networking system may enable its users (such as persons or organizations) to interact with the system and with each other. The social networking system may, with input from a user, create and store in the social networking system a user profile associated with the user. As described above, the user profile may include demographic information, communication channel information, and information on personal interests of the user.

In more detail, user profile information may include, for example, biographic information, demographic information, behavioral information, the social information, or other types of descriptive information, such as work experience, educational history, hobbies or preferences, interests, affinities, or location. Interest information may include interests related to one or more categories, which may be general or specific. As an example, if a user “likes” an article about a brand of shoes, the category may be the brand.

The social networking system may also, with input from a user, create and store a record of relationships of the user with other users of the social networking system, as well as provide services (e.g., wall posts, photo-sharing, online calendars and event organization, messaging, games, or advertisements) to facilitate social interaction between or among users. Also, the social networking system may allow users to post photographs and other multimedia content items to a user's profile page (typically known as “wall posts” or “timeline posts”) or in a photo album, both of which may be accessible to other users of the social networking system depending on the user's configured privacy settings. Herein, the term “friend” may refer to any other user of the social networking system with which a user has formed a connection, association, or relationship via the social networking system.

FIG. 19 illustrates an example network environment 1900 of a social networking system. Network environment 1900 includes a client device 1906, a networking system 1902 (e.g., a social networking system and/or an electronic messaging system), and a third-party system 1908 connected to each other by a network 1904. Although FIG. 19 illustrates a particular arrangement of client device 1906, networking system 1902, third-party system 1908, and network 1904, this disclosure contemplates any suitable arrangement of client device 1906, networking system 1902, third-party system 1908, and network 1904. As an example and not by way of limitation, two or more of client device 1906, networking system 1902, and third-party system 1908 may be connected to each other directly, bypassing network 1904. As another example, two or more of client device 1906, networking system 1902, and third-party system 1908 may be physically or logically co-located with each other in whole or in part. Moreover, although FIG. 19 illustrates a particular number of client devices 1906, networking systems 1902, third-party systems 1908, and networks 1904, this disclosure contemplates any suitable number of client devices 1906, networking systems 1902, third-party systems 1908, and networks 1904. As an example and not by way of limitation, network environment 1900 may include multiple client device 1906, networking systems 1902, third-party systems 1908, and networks 1904.

This disclosure contemplates any suitable network 1904. As an example and not by way of limitation, one or more portions of network 1904 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or a combination of two or more of these. Network 1904 may include one or more networks 1904.

Links may connect client device 1906, networking system 1902, and third-party system 1908 to communication network 1904 or to each other. This disclosure contemplates any suitable links. In particular embodiments, one or more links include one or more wireline (such as for example Digital Subscriber Line (DSL) or Data Over Cable Service Interface Specification (DOCSIS)), wireless (such as for example Wi-Fi or Worldwide Interoperability for Microwave Access (WiMAX)), or optical (such as for example Synchronous Optical Network (SONET) or Synchronous Digital Hierarchy (SDH)) links. In particular embodiments, one or more links each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link, or a combination of two or more such links. Links need not necessarily be the same throughout network environment 1900. One or more first links may differ in one or more respects from one or more second links.

In particular embodiments, client device 1906 may be an electronic device including hardware, software, or embedded logic components or a combination of two or more such components and capable of carrying out the appropriate functionalities implemented or supported by client device 1906. As an example and not by way of limitation, a client device 1906 may include a computer system such as an augmented reality display device, a desktop computer, notebook or laptop computer, netbook, a tablet computer, e-book reader, GPS device, camera, personal digital assistant (PDA), handheld electronic device, cellular telephone, smartphone, other suitable electronic device, or any suitable combination thereof. This disclosure contemplates any suitable client devices 1906. A client device 1906 may enable a network user at client device 1906 to access network 1904. A client device 1906 may enable its user to communicate with other users at other client devices 1906.

In particular embodiments, client device 1906 may include a web browser, and may have one or more add-ons, plug-ins, or other extensions. A user at client device 1906 may enter a Uniform Resource Locator (URL) or other address directing the web browser to a particular server (such as server, or a server associated with a third-party system 1908), and the web browser may generate a Hyper Text Transfer Protocol (HTTP) request and communicate the HTTP request to server. The server may accept the HTTP request and communicate to client device 1906 one or more Hyper Text Markup Language (HTML) files responsive to the HTTP request. Client device 1906 may render a webpage based on the HTML files from the server for presentation to the user. This disclosure contemplates any suitable webpage files. As an example and not by way of limitation, webpages may render from HTML files, Extensible Hyper Text Markup Language (XHTML) files, or Extensible Markup Language (XML) files, according to particular needs. Such pages may also execute scripts such as, for example and without limitation, those written in JAVASCRIPT, JAVA, MICROSOFT SILVERLIGHT, combinations of markup language and scripts such as AJAX (Asynchronous JAVASCRIPT and XML), and the like. Herein, reference to a webpage encompasses one or more corresponding webpage files (which a browser may use to render the webpage) and vice versa, where appropriate.

In particular embodiments, networking system 1902 may be a network-addressable computing system that can host an online social network. Networking system 1902 may generate, store, receive, and send social-networking data, such as, for example, user-profile data, concept-profile data, social-graph information, or other suitable data related to the online social network. Networking system 1902 may be accessed by the other components of network environment 1900 either directly or via network 1904. In particular embodiments, networking system 1902 may include one or more servers. Each server may be a unitary server or a distributed server spanning multiple computers or multiple datacenters. Servers may be of various types, such as, for example and without limitation, web server, news server, mail server, message server, advertising server, file server, application server, exchange server, database server, proxy server, another server suitable for performing functions or processes described herein, or any combination thereof. In particular embodiments, each server may include hardware, software, or embedded logic components or a combination of two or more such components for carrying out the appropriate functionalities implemented or supported by server. In particular embodiments, networking system 1902 may include one or more data stores. Data stores may be used to store various types of information. In particular embodiments, the information stored in data stores may be organized according to specific data structures. In particular embodiments, each data store may be a relational, columnar, correlation, or other suitable database. Although this disclosure describes or illustrates particular types of databases, this disclosure contemplates any suitable types of databases. Particular embodiments may provide interfaces that enable a client device 1906, a networking system 1902, or a third-party system 1908 to manage, retrieve, modify, add, or delete, the information stored in data store.

In particular embodiments, networking system 1902 may store one or more social graphs in one or more data stores. In particular embodiments, a social graph may include multiple nodes—which may include multiple user nodes (each corresponding to a particular user) or multiple concept nodes (each corresponding to a particular concept)—and multiple edges connecting the nodes. Networking system 1902 may provide users of the online social network the ability to communicate and interact with other users. In particular embodiments, users may join the online social network via networking system 1902 and then add connections (e.g., relationships) to a number of other users of networking system 1902 that they want to be connected to. Herein, the term “friend” may refer to any other user of networking system 1902 with whom a user has formed a connection, association, or relationship via networking system 1902.

In particular embodiments, networking system 1902 may provide users with the ability to take actions on various types of items or objects, supported by networking system 1902. As an example and not by way of limitation, the items and objects may include groups or social networks to which users of networking system 1902 may belong, events or calendar entries in which a user might be interested, computer-based applications that a user may use, transactions that allow users to buy or sell items via the service, interactions with advertisements that a user may perform, or other suitable items or objects. A user may interact with anything that is capable of being represented in networking system 1902 or by an external system of third-party system 1908, which is separate from networking system 1902 and coupled to networking system 1902 via a network 1904.

In particular embodiments, networking system 1902 may be capable of linking a variety of entities. As an example and not by way of limitation, networking system 1902 may enable users to interact with each other as well as receive content from third-party systems 1908 or other entities, or to allow users to interact with these entities through an application programming interfaces (API) or other communication channels.

In particular embodiments, a third-party system 1908 may include one or more types of servers, one or more data stores, one or more interfaces, including but not limited to APIs, one or more web services, one or more content sources, one or more networks, or any other suitable components, e.g., that servers may communicate with. A third-party system 1908 may be operated by a different entity from an entity operating networking system 1902. In particular embodiments, however, networking system 1902 and third-party systems 1908 may operate in conjunction with each other to provide social-networking services to users of networking system 1902 or third-party systems 1908. In this sense, networking system 1902 may provide a platform, or backbone, which other systems, such as third-party systems 1908, may use to provide social-networking services and functionality to users across the Internet.

In particular embodiments, a third-party system 1908 may include a third-party content object provider. A third-party content object provider may include one or more sources of content objects, which may be communicated to a client device 1906. As an example and not by way of limitation, content objects may include information regarding things or activities of interest to the user, such as, for example, movie show times, movie reviews, restaurant reviews, restaurant menus, product information and reviews, or other suitable information. As another example and not by way of limitation, content objects may include incentive content objects, such as coupons, discount tickets, gift certificates, or other suitable incentive objects.

In particular embodiments, networking system 1902 also includes user-generated content objects, which may enhance a user's interactions with networking system 1902. User-generated content may include anything a user can add, upload, send, or “post” to networking system 1902. As an example and not by way of limitation, a user communicates posts to networking system 1902 from a client device 1906. Posts may include data such as status updates or other textual data, location information, photos, videos, links, music or other similar data or media. Content may also be added to networking system 1902 by a third-party through a “communication channel,” such as a newsfeed or stream.

In particular embodiments, networking system 1902 may include a variety of servers, sub-systems, programs, modules, logs, and data stores. In particular embodiments, networking system 1902 may include one or more of the following: a web server, action logger, API-request server, relevance-and-ranking engine, content-object classifier, notification controller, action log, third-party-content-object-exposure log, inference module, authorization/privacy server, search module, advertisement-targeting module, user-interface module, user-profile store, connection store, third-party content store, or location store. Networking system 1902 may also include suitable components such as network interfaces, security mechanisms, load balancers, failover servers, management-and-network-operations consoles, other suitable components, or any suitable combination thereof. In particular embodiments, networking system 1902 may include one or more user-profile stores for storing user profiles. A user profile may include, for example, biographic information, demographic information, behavioral information, social information, or other types of descriptive information, such as work experience, educational history, hobbies or preferences, interests, affinities, or location. Interest information may include interests related to one or more categories. Categories may be general or specific. As an example and not by way of limitation, if a user “likes” an article about a brand of shoes the category may be the brand, or the general category of “shoes” or “clothing.” A connection store may be used for storing connection information about users. The connection information may indicate users who have similar or common work experience, group memberships, hobbies, educational history, or are in any way related or share common attributes. The connection information may also include user-defined connections between different users and content (both internal and external). A web server may be used for linking networking system 1902 to one or more client devices 1906 or one or more third-party system 1908 via network 1904. The web server may include a mail server or other messaging functionality for receiving and routing messages between networking system 1902 and one or more client devices 1906. An API-request server may allow a third-party system 1908 to access information from networking system 1902 by calling one or more APIs. An action logger may be used to receive communications from a web server about a user's actions on or off networking system 1902. In conjunction with the action log, a third-party-content-object log may be maintained of user exposures to third-party-content objects. A notification controller may provide information regarding content objects to a client device 1906. Information may be pushed to a client device 1906 as notifications, or information may be pulled from client device 1906 responsive to a request received from client device 1906.

Authorization servers may be used to enforce one or more privacy settings of the users of networking system 1902. A privacy setting of a user determines how particular information associated with a user can be shared. The authorization server may allow users to opt in to or opt out of having their actions logged by networking system 1902 or shared with other systems (e.g., third-party system 1908), such as, for example, by setting appropriate privacy settings. Third-party-content-object stores may be used to store content objects received from third parties, such as a third-party system 1908. Location stores may be used for storing location information received from client devices 1906 associated with users. Advertisement-pricing modules may combine social information, the current time, location information, or other suitable information to provide relevant advertisements, in the form of notifications, to a user.

FIG. 20 illustrates example social graph 2000. In particular embodiments, networking system 1902 may store one or more social graphs 2000 in one or more data stores. In particular embodiments, social graph 2000 may include multiple nodes—which may include multiple user nodes 2002 or multiple concept nodes 2004—and multiple edges 2006 connecting the nodes. Example social graph 2000 illustrated in FIG. 20 is shown, for didactic purposes, in a two-dimensional visual map representation. In particular embodiments, a networking system 1902, client device 1906, or third-party system 1908 may access social graph 2000 and related social-graph information for suitable applications. The nodes and edges of social graph 2000 may be stored as data objects, for example, in a data store (such as a social-graph database). Such a data store may include one or more searchable or query able indexes of nodes or edges of social graph 2000.

In particular embodiments, a user node 2002 may correspond to a user of networking system 1902. As an example and not by way of limitation, a user may be an individual (human user), an entity (e.g., an enterprise, business, or third-party application), or a group (e.g., of individuals or entities) that interacts or communicates with or over networking system 1902. In particular embodiments, when a user registers for an account with networking system 1902, networking system 1902 may create a user node 2002 corresponding to the user, and store the user node 2002 in one or more data stores. Users and user nodes 2002 described herein may, where appropriate, refer to registered users and user nodes 2002 associated with registered users. In addition, or as an alternative, users, and user nodes 2002 described herein may, where appropriate, refer to users that have not registered with networking system 1902. In particular embodiments, a user node 2002 may be associated with information provided by a user or information gathered by various systems, including networking system 1902. As an example and not by way of limitation, a user may provide his or her name, profile picture, contact information, birth date, sex, marital status, family status, employment, education background, preferences, interests, or other demographic information. In particular embodiments, a user node 2002 may be associated with one or more data objects corresponding to information associated with a user. In particular embodiments, a user node 2002 may correspond to one or more webpages.

In particular embodiments, a concept node 2004 may correspond to a concept. As an example and not by way of limitation, a concept may correspond to a place (such as, for example, a movie theater, restaurant, landmark, or city); a website (such as, for example, a website associated with networking system 1902 or a third-party website associated with a web-application server); an entity (such as, for example, a person, business, group, sports team, or celebrity); a resource (such as, for example, an audio file, video file, digital photo, text file, structured document, or application) which may be located within networking system 1902 or on an external server, such as a web-application server; real or intellectual property (such as, for example, a sculpture, painting, movie, game, song, idea, photograph, or written work); a game; an activity; an idea or theory; another suitable concept; or two or more such concepts. A concept node 2004 may be associated with information of a concept provided by a user or information gathered by various systems, including networking system 1902. As an example and not by way of limitation, information of a concept may include a name or a title; one or more images (e.g., an image of the cover page of a book); a location (e.g., an address or a geographical location); a website (which may be associated with a URL); contact information (e.g., a phone number or an email address); other suitable concept information; or any suitable combination of such information. In particular embodiments, a concept node 2004 may be associated with one or more data objects corresponding to information associated with concept node 2004. In particular embodiments, a concept node 2004 may correspond to one or more webpages.

In particular embodiments, a node in social graph 2000 may represent or be represented by a webpage (which may be referred to as a “profile page”). Profile pages may be hosted by or accessible to networking system 1902. Profile pages may also be hosted on third-party websites associated with a third-party system 1908. As an example and not by way of limitation, a profile page corresponding to a particular external webpage may be the particular external webpage and the profile page may correspond to a particular concept node 2004. Profile pages may be viewable by all or a selected subset of other users. As an example and not by way of limitation, a user node 2002 may have a corresponding user-profile page in which the corresponding user may add content, make declarations, or otherwise express himself or herself. As another example and not by way of limitation, a concept node 2004 may have a corresponding concept-profile page in which one or more users may add content, make declarations, or express themselves, particularly in relation to the concept corresponding to concept node 2004.

In particular embodiments, a concept node 2004 may represent a third-party webpage or resource hosted by a third-party system 1908. The third-party webpage or resource may include, among other elements, content, a selectable or other icon, or other inter-actable object (which may be implemented, for example, in JavaScript, AJAX, or PHP codes) representing an action or activity. As an example and not by way of limitation, a third-party webpage may include a selectable icon such as “like,” “check in,” “eat,” “recommend,” or another suitable action or activity. A user viewing the third-party webpage may perform an action by selecting one of the icons (e.g., “eat”), causing a client device 1906 to send to networking system 1902 a message indicating the user's action. In response to the message, networking system 1902 may create an edge (e.g., an “eat” edge) between a user node 2002 corresponding to the user and a concept node 2004 corresponding to the third-party webpage or resource and store edge 2006 in one or more data stores.

In particular embodiments, a pair of nodes in social graph 2000 may be connected to each other by one or more edges 2006. An edge 2006 connecting a pair of nodes may represent a relationship between the pair of nodes. In particular embodiments, an edge 2006 may include or represent one or more data objects or attributes corresponding to the relationship between a pair of nodes. As an example and not by way of limitation, a first user may indicate that a second user is a “friend” of the first user. In response to this indication, networking system 1902 may send a “friend request” to the second user. If the second user confirms the “friend request,” networking system 1902 may create an edge 2006 connecting the first user's user node 2002 to the second user's user node 2002 in social graph 2000 and store edge 2006 as social-graph information in one or more of data stores. In the example of FIG. 20, social graph 2000 includes an edge 2006 indicating a friend relation between user nodes 2002 of user “A” and user “B” and an edge indicating a friend relation between user nodes 2002 of user “C” and user “B.” Although this disclosure describes or illustrates particular edges 2006 with particular attributes connecting particular user nodes 2002, this disclosure contemplates any suitable edges 2006 with any suitable attributes connecting user nodes 2002. As an example and not by way of limitation, an edge 2006 may represent a friendship, family relationship, business or employment relationship, fan relationship, follower relationship, visitor relationship, subscriber relationship, superior/subordinate relationship, reciprocal relationship, non-reciprocal relationship, another suitable type of relationship, or two or more such relationships. Moreover, although this disclosure generally describes nodes as being connected, this disclosure also describes users or concepts as being connected. Herein, references to users or concepts being connected may, where appropriate, refer to the nodes corresponding to those users or concepts being connected in social graph 2000 by one or more edges 2006.

In particular embodiments, an edge 2006 between a user node 2002 and a concept node 2004 may represent a particular action or activity performed by a user associated with user node 2002 toward a concept associated with a concept node 2004. As an example and not by way of limitation, as illustrated in FIG. 20, a user may “like,” “attended,” “played,” “listened,” “cooked,” “worked at,” or “watched” a concept, each of which may correspond to an edge type or subtype. A concept-profile page corresponding to a concept node 2004 may include, for example, a selectable “check in” icon (such as, for example, a clickable “check in” icon) or a selectable “add to favorites” icon. Similarly, after a user clicks these icons, networking system 1902 may create a “favorite” edge or a “check in” edge in response to a user's action corresponding to a respective action. As another example and not by way of limitation, a user (user “C”) may listen to a particular song (“Ramble On”) using a particular application (MUSIC, which is an online music application). In this case, networking system 1902 may create a “listened” edge 2006 and a “used” edge (as illustrated in FIG. 20) between user nodes 2002 corresponding to the user and concept nodes 2004 corresponding to the song and application to indicate that the user listened to the song and used the application. Moreover, networking system 1902 may create a “played” edge 2006 (as illustrated in FIG. 20) between concept nodes 2004 corresponding to the song and the application to indicate that the particular song was played by the particular application. In this case, “played” edge 2006 corresponds to an action performed by an external application (MUSIC) on an external audio file (the song “Imagine”). Although this disclosure describes particular edges 2006 with particular attributes connecting user nodes 2002 and concept nodes 2004, this disclosure contemplates any suitable edges 2006 with any suitable attributes connecting user nodes 2002 and concept nodes 2004. Moreover, although this disclosure describes edges between a user node 2002 and a concept node 2004 representing a single relationship, this disclosure contemplates edges between a user node 2002 and a concept node 2004 representing one or more relationships. As an example and not by way of limitation, an edge 2006 may represent both that a user likes and has used at a particular concept. Alternatively, another edge 2006 may represent each type of relationship (or multiples of a single relationship) between a user node 2002 and a concept node 2004 (as illustrated in FIG. 20 between user node 2002 for user “E” and concept node 2004 for “MUSIC”).

In particular embodiments, networking system 1902 may create an edge 2006 between a user node 2002 and a concept node 2004 in social graph 2000. As an example and not by way of limitation, a user viewing a concept-profile page (such as, for example, by using a web browser or a special-purpose application hosted by the user's client device 1906) may indicate that he or she likes the concept represented by the concept node 2004 by clicking or selecting a “Like” icon, which may cause the user's client device 1906 to send to networking system 1902 a message indicating the user's liking of the concept associated with the concept-profile page. In response to the message, networking system 1902 may create an edge 2006 between user node 2002 associated with the user and concept node 2004, as illustrated by “like” edge 2006 between the user and concept node 2004. In particular embodiments, networking system 1902 may store an edge 2006 in one or more data stores. In particular embodiments, an edge 2006 may be automatically formed by networking system 1902 in response to a particular user action. As an example and not by way of limitation, if a first user uploads a picture, watches a movie, or listens to a song, an edge 2006 may be formed between user node 2002 corresponding to the first user and concept nodes 2004 corresponding to those concepts. Although this disclosure describes forming particular edges 2006 in particular manners, this disclosure contemplates forming any suitable edges 2006 in any suitable manner.

In particular embodiments, an advertisement may be text (which may be HTML-linked), one or more images (which may be HTML-linked), one or more videos, audio, one or more ADOBE FLASH files, a suitable combination of these, or any other suitable advertisement in any suitable digital format presented on one or more webpages, in one or more e-mails, or in connection with search results requested by a user. In addition or as an alternative, an advertisement may be one or more sponsored stories (e.g., a news-feed or ticker item on networking system 1902). A sponsored story may be a social action by a user (such as “liking” a page, “liking” or commenting on a post on a page, RSVPing to an event associated with a page, voting on a question posted on a page, checking in to a place, using an application or playing a game, or “liking” or sharing a website) that an advertiser promotes, for example, by having the social action presented within a pre-determined area of a profile page of a user or other page, presented with additional information associated with the advertiser, bumped up or otherwise highlighted within news feeds or tickers of other users, or otherwise promoted. The advertiser may pay to have the social action promoted. As an example and not by way of limitation, advertisements may be included among the search results of a search-results page, where sponsored content is promoted over non-sponsored content.

In particular embodiments, an advertisement may be requested for display within social-networking-system webpages, third-party webpages, or other pages. An advertisement may be displayed in a dedicated portion of a page, such as in a banner area at the top of the page, in a column at the side of the page, in a GUI of the page, in a pop-up window, in a drop-down menu, in an input field of the page, over the top of content of the page, or elsewhere with respect to the page. In addition or as an alternative, an advertisement may be displayed within an application. An advertisement may be displayed within dedicated pages, requiring the user to interact with or watch the advertisement before the user may access a page or utilize an application. The user may, for example view the advertisement through a web browser.

A user may interact with an advertisement in any suitable manner. The user may click or otherwise select the advertisement. By selecting the advertisement, the user may be directed to (or a browser or other application being used by the user) a page associated with the advertisement. At the page associated with the advertisement, the user may take additional actions, such as purchasing a product or service associated with the advertisement, receiving information associated with the advertisement, or subscribing to a newsletter associated with the advertisement. An advertisement with audio or video may be played by selecting a component of the advertisement (like a “play button”). Alternatively, by selecting the advertisement, networking system 1902 may execute or modify a particular action of the user.

An advertisement may also include social-networking-system functionality that a user may interact with. As an example and not by way of limitation, an advertisement may enable a user to “like” or otherwise endorse the advertisement by selecting an icon or link associated with endorsement. As another example and not by way of limitation, an advertisement may enable a user to search (e.g., by executing a query) for content related to the advertiser. Similarly, a user may share the advertisement with another user (e.g., through networking system 1902) or RSVP (e.g., through networking system 1902) to an event associated with the advertisement. In addition or as an alternative, an advertisement may include social-networking-system context directed to the user. As an example and not by way of limitation, an advertisement may display information about a friend of the user within networking system 1902 who has taken an action associated with the subject matter of the advertisement.

In particular embodiments, networking system 1902 may determine the social-graph affinity (which may be referred to herein as “affinity”) of various social-graph entities for each other. Affinity may represent the strength of a relationship or level of interest between particular objects associated with the online social network, such as users, concepts, content, actions, advertisements, other objects associated with the online social network, or any suitable combination thereof. Affinity may also be determined with respect to objects associated with third-party systems 1908 or other suitable systems. An overall affinity for a social-graph entity for each user, subject matter, or type of content may be established. The overall affinity may change based on continued monitoring of the actions or relationships associated with the social-graph entity. Although this disclosure describes determining particular affinities in a particular manner, this disclosure contemplates determining any suitable affinities in any suitable manner.

In particular embodiments, networking system 1902 may measure or quantify social-graph affinity using an affinity coefficient (which may be referred to herein as “coefficient”). The coefficient may represent or quantify the strength of a relationship between particular objects associated with the online social network. The coefficient may also represent a probability or function that measures a predicted probability that a user will perform a particular action based on the user's interest in the action. In this way, a user's future actions may be predicted based on the user's prior actions, where the coefficient may be calculated at least in part based on the history of the user's actions. Coefficients may be used to predict any number of actions, which may be within or outside of the online social network. As an example and not by way of limitation, these actions may include various types of communications, such as sending messages, posting content, or commenting on content; various types of observation actions, such as accessing or viewing profile pages, media, or other suitable content; various types of coincidence information about two or more social-graph entities, such as being in the same group, tagged in the same photograph, checked-in at the same location, or attending the same event; or other suitable actions. Although this disclosure describes measuring affinity in a particular manner, this disclosure contemplates measuring affinity in any suitable manner.

In particular embodiments, networking system 1902 may use a variety of factors to calculate a coefficient. These factors may include, for example, user actions, types of relationships between objects, location information, other suitable factors, or any combination thereof. In particular embodiments, different factors may be weighted differently when calculating the coefficient. The weights for each factor may be static or the weights may change according to, for example, the user, the type of relationship, the type of action, the user's location, and so forth. Ratings for the factors may be combined according to their weights to determine an overall coefficient for the user. As an example and not by way of limitation, particular user actions may be assigned both a rating and a weight while a relationship associated with the particular user action is assigned a rating and a correlating weight (e.g., so the weights total 100%). To calculate the coefficient of a user towards a particular object, the rating assigned to the user's actions may comprise, for example, 60% of the overall coefficient, while the relationship between the user and the object may comprise 40% of the overall coefficient. In particular embodiments, the networking system 1902 may consider a variety of variables when determining weights for various factors used to calculate a coefficient, such as, for example, the time since information was accessed, decay factors, frequency of access, relationship to information or relationship to the object about which information was accessed, relationship to social-graph entities connected to the object, short- or long-term averages of user actions, user feedback, other suitable variables, or any combination thereof. As an example and not by way of limitation, a coefficient may include a decay factor that causes the strength of the signal provided by particular actions to decay with time, such that more recent actions are more relevant when calculating the coefficient. The ratings and weights may be continuously updated based on continued tracking of the actions upon which the coefficient is based. Any type of process or algorithm may be employed for assigning, combining, averaging, and so forth the ratings for each factor and the weights assigned to the factors. In particular embodiments, networking system 1902 may determine coefficients using machine-learning algorithms trained on historical actions and past user responses, or data farmed from users by exposing them to various options and measuring responses. Although this disclosure describes calculating coefficients in a particular manner, this disclosure contemplates calculating coefficients in any suitable manner.

In particular embodiments, networking system 1902 may calculate a coefficient based on a user's actions. Networking system 1902 may monitor such actions on the online social network, on a third-party system 1908, on other suitable systems, or any combination thereof. Any suitable type of user actions may be tracked or monitored. Typical user actions include viewing profile pages, creating or posting content, interacting with content, joining groups, listing, and confirming attendance at events, checking-in at locations, liking particular pages, creating pages, and performing other tasks that facilitate social action. In particular embodiments, networking system 1902 may calculate a coefficient based on the user's actions with particular types of content. The content may be associated with the online social network, a third-party system 1908, or another suitable system. The content may include users, profile pages, posts, news stories, headlines, instant messages, chat room conversations, emails, advertisements, pictures, video, music, other suitable objects, or any combination thereof. Networking system 1902 may analyze a user's actions to determine whether one or more of the actions indicate an affinity for subject matter, content, other users, and so forth. As an example and not by way of limitation, if a user may make frequently posts content related to “coffee” or variants thereof, networking system 1902 may determine the user has a high coefficient with respect to the concept “coffee.” Particular actions or types of actions may be assigned a higher weight and/or rating than other actions, which may affect the overall calculated coefficient. As an example and not by way of limitation, if a first user emails a second user, the weight or the rating for the action may be higher than if the first user simply views the user-profile page for the second user.

In particular embodiments, networking system 1902 may calculate a coefficient based on the type of relationship between particular objects. Referencing the social graph 2000, networking system 1902 may analyze the number and/or type of edges 2006 connecting particular user nodes 2002 and concept nodes 2004 when calculating a coefficient. As an example and not by way of limitation, user nodes 2002 that are connected by a spouse-type edge (representing that the two users are married) may be assigned a higher coefficient than a user node 2002 that are connected by a friend-type edge. In other words, depending upon the weights assigned to the actions and relationships for the particular user, the overall affinity may be determined to be higher for content about the user's spouse than for content about the user's friend. In particular embodiments, the relationships a user has with another object may affect the weights and/or the ratings of the user's actions with respect to calculating the coefficient for that object. As an example and not by way of limitation, if a user is tagged in first photo, but merely likes a second photo, networking system 1902 may determine that the user has a higher coefficient with respect to the first photo than the second photo because having a tagged-in-type relationship with content may be assigned a higher weight and/or rating than having a like-type relationship with content. In particular embodiments, networking system 1902 may calculate a coefficient for a first user based on the relationship one or more second users have with a particular object. In other words, the connections and coefficients other users have with an object may affect the first user's coefficient for the object. As an example and not by way of limitation, if a first user is connected to or has a high coefficient for one or more second users, and those second users are connected to or have a high coefficient for a particular object, networking system 1902 may determine that the first user should also have a relatively high coefficient for the particular object. In particular embodiments, the coefficient may be based on the degree of separation between particular objects. The lower coefficient may represent the decreasing likelihood that the first user will share an interest in content objects of the user that is indirectly connected to the first user in the social graph 2000. As an example and not by way of limitation, social-graph entities that are closer in the social graph 2000 (i.e., fewer degrees of separation) may have a higher coefficient than entities that are further apart in the social graph 2000.

In particular embodiments, networking system 1902 may calculate a coefficient based on location information. Objects that are geographically closer to each other may be considered to be more related, or of more interest, to each other than more distant objects. In particular embodiments, the coefficient of a user towards a particular object may be based on the proximity of the object's location to a current location associated with the user (or the location of a client device 1906 of the user). A first user may be more interested in other users or concepts that are closer to the first user. As an example and not by way of limitation, if a user is one mile from an airport and two miles from a gas station, networking system 1902 may determine that the user has a higher coefficient for the airport than the gas station based on the proximity of the airport to the user.

In particular embodiments, networking system 1902 may perform particular actions with respect to a user based on coefficient information. Coefficients may be used to predict whether a user will perform a particular action based on the user's interest in the action. A coefficient may be used when generating or presenting any type of objects to a user, such as advertisements, search results, news stories, media, messages, notifications, or other suitable objects. The coefficient may also be utilized to rank and order such objects, as appropriate. In this way, networking system 1902 may provide information that is relevant to user's interests and current circumstances, increasing the likelihood that they will find such information of interest. In particular embodiments, networking system 1902 may generate content based on coefficient information. Content objects may be provided or selected based on coefficients specific to a user. As an example and not by way of limitation, the coefficient may be used to generate media for the user, where the user may be presented with media for which the user has a high overall coefficient with respect to the media object. As another example and not by way of limitation, the coefficient may be used to generate advertisements for the user, where the user may be presented with advertisements for which the user has a high overall coefficient with respect to the advertised object. In particular embodiments, networking system 1902 may generate search results based on coefficient information. Search results for a particular user may be scored or ranked based on the coefficient associated with the search results with respect to the querying user. As an example and not by way of limitation, search results corresponding to objects with higher coefficients may be ranked higher on a search-results page than results corresponding to objects having lower coefficients.

In particular embodiments, networking system 1902 may calculate a coefficient in response to a request for a coefficient from a particular system or process. To predict the likely actions a user may take (or may be the subject of) in a given situation, any process may request a calculated coefficient for a user. The request may also include a set of weights to use for various factors used to calculate the coefficient. This request may come from a process running on the online social network, from a third-party system 1908 (e.g., via an API or other communication channel), or from another suitable system. In response to the request, networking system 1902 may calculate the coefficient (or access the coefficient information if it has previously been calculated and stored). In particular embodiments, networking system 1902 may measure an affinity with respect to a particular process. Different processes (both internal and external to the online social network) may request a coefficient for a particular object or set of objects. Networking system 1902 may provide a measure of affinity that is relevant to the particular process that requested the measure of affinity. In this way, each process receives a measure of affinity that is tailored for the different context in which the process will use the measure of affinity.

In connection with social-graph affinity and affinity coefficients, particular embodiments may utilize one or more systems, components, elements, functions, methods, operations, or steps disclosed in U.S. patent application Ser. No. 11/503,093, filed 11 Aug. 2006, U.S. patent application Ser. No. 12/971,9027, filed 22 Dec. 2010, U.S. patent application Ser. No. 12/978,265, filed 23 Dec. 2010, and U.S. patent application Ser. No. 13/632,869, field 1 Oct. 2012, each of which is incorporated by reference.

In particular embodiments, one or more of the content objects of the online social network may be associated with a privacy setting. The privacy settings (or “access settings”) for an object may be stored in any suitable manner, such as, for example, in association with the object, in an index on an authorization server, in another suitable manner, or any combination thereof. A privacy setting of an object may specify how the object (or particular information associated with an object) can be accessed (e.g., viewed or shared) using the online social network. Where the privacy settings for an object allow a particular user to access that object, the object may be described as being “visible” with respect to that user. As an example and not by way of limitation, a user of the online social network may specify privacy settings for a user-profile page identify a set of users that may access the work experience information on the user-profile page, thus excluding other users from accessing the information. In particular embodiments, the privacy settings may specify a “blocked list” of users that should not be allowed to access certain information associated with the object. In other words, the blocked list may specify one or more users or entities for which an object is not visible. As an example and not by way of limitation, a user may specify a set of users that may not access photos albums associated with the user, thus excluding those users from accessing the photo albums (while also possibly allowing certain users not within the set of users to access the photo albums). In particular embodiments, privacy settings may be associated with particular social-graph elements. Privacy settings of a social-graph element, such as a node or an edge, may specify how the social-graph element, information associated with the social-graph element, or content objects associated with the social-graph element can be accessed using the online social network. As an example and not by way of limitation, a particular concept node 2004 corresponding to a particular photo may have a privacy setting specifying that the photo may only be accessed by users tagged in the photo and their friends. In particular embodiments, privacy settings may allow users to opt in or opt out of having their actions logged by networking system 1902 or shared with other systems (e.g., third-party system 1908). In particular embodiments, the privacy settings associated with an object may specify any suitable granularity of permitted access or denial of access. As an example and not by way of limitation, access or denial of access may be specified for particular users (e.g., only me, my roommates, and my boss), users within a particular degrees-of-separation (e.g., friends, or friends-of-friends), user groups (e.g., the gaming club, my family), user networks (e.g., employees of particular employers, students or alumni of particular university), all users (“public”), no users (“private”), users of third-party systems 1908, particular applications (e.g., third-party applications, external websites), other suitable users or entities, or any combination thereof. Although this disclosure describes using particular privacy settings in a particular manner, this disclosure contemplates using any suitable privacy settings in any suitable manner.

In particular embodiments, one or more servers may be authorization/privacy servers for enforcing privacy settings. In response to a request from a user (or other entity) for a particular object stored in a data store, networking system 1902 may send a request to the data store for the object. The request may identify the user associated with the request and may only be sent to the user (or a client device 1906 of the user) if the authorization server determines that the user is authorized to access the object based on the privacy settings associated with the object. If the requesting user is not authorized to access the object, the authorization server may prevent the requested object from being retrieved from the data store, or may prevent the requested object from be sent to the user. In the search query context, an object may only be generated as a search result if the querying user is authorized to access the object. In other words, the object must have a visibility that is visible to the querying user. If the object has a visibility that is not visible to the user, the object may be excluded from the search results. Although this disclosure describes enforcing privacy settings in a particular manner, this disclosure contemplates enforcing privacy settings in any suitable manner.

The foregoing specification is described with reference to specific exemplary embodiments thereof. Various embodiments and aspects of the disclosure are described with reference to details discussed herein, and the accompanying drawings illustrate the various embodiments. The description above and drawings are illustrative and are not to be construed as limiting. Numerous specific details are described to provide a thorough understanding of various embodiments.

The additional or alternative embodiments may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

What is claimed is:

1. A computer-implemented method comprising:
conducting, by a client device, a video call with a participant device through a streaming channel established for the video call from the participant device;
rendering, within a video call interface displayed on the client device, a video cell portraying a video utilizing video data received from the participant device in a grid-view display format; and
upon detecting a user interaction indicating a request to display a custom video call interface layout, rendering the video cell within a custom video call interface on the client device in a self-view display format.

2. The computer-implemented method of claim 1, further comprising, upon detecting the user interaction indicating the request to display the custom video call interface layout, rendering an additional video cell portraying an additional video utilizing additional video data captured by the client device within the custom video call interface in the self-view display format.

3. The computer-implemented method of claim 1, wherein rendering the video cell within the custom video call interface comprises modifying a visual property of the video cell based on the custom video call interface.

4. The computer-implemented method of claim 3, further comprising modifying the visual property of the video cell based on detecting a user interaction with the video cell or the custom video call interface.

5. The computer-implemented method of claim 3, wherein modifying the visual property of the video cell comprises changing a size, a shape, or a position of the video cell.

6. The computer-implemented method of claim 1, wherein rendering the video cell within the custom video call interface comprises dynamically moving the video cell within the custom video call interface during the video call.

7. The computer-implemented method of claim 1, further comprising rendering the custom video call interface by rendering an interactive object within the custom video call interface.

8. The computer-implemented method of claim 7, further comprising updating the interactive object upon receiving a user interaction corresponding to the interactive object.

9. The computer-implemented method of claim 7, wherein the interactive object comprises a material or an interactive application.

10. The computer-implemented method of claim 9, wherein the interactive application comprises an electronic paint application, an electronic document application, digital content streaming application, a video game application, a music development application, or a media browsing library application.

11. A non-transitory computer-readable medium storing instructions that, when executed by at least one processor, cause the at least one processor to:
conduct, by a client device, a video call with a participant device through a streaming channel established for the video call from the participant device;
render, within a video call interface displayed on the client device, a video cell portraying a video utilizing video data received from the participant device in a grid-view display format; and
upon detecting a user interaction indicating a request to display a custom video call interface layout, render the video cell within a custom video call interface on the client device in a self-view display format.

12. The non-transitory computer-readable medium of claim 11, wherein rendering the video cell within the custom video call interface comprises:
modifying a visual property of the video cell, wherein the visual property of the video cell comprises a size, a shape, or a position corresponding to the video cell; or
applying a movement property to the video cell, wherein the movement property comprises a mass value, a collision boundary, a gravity value, a friction value, or an elasticity value corresponding to the video cell.

13. The non-transitory computer-readable medium of claim 12, further comprising instructions that, when executed by the at least one processor, cause the at least one processor to modify the video from the video data to fit the modified visual property of the video cell.

14. The non-transitory computer-readable medium of claim 11, further comprising instructions that, when executed by the at least one processor, cause the at least one processor to render the custom video call interface by rendering an interactive object within the custom video call interface.

15. The non-transitory computer-readable medium of claim 14, further comprising instructions that, when executed by the at least one processor, cause the at least one processor to update the interactive object upon receiving a user interaction corresponding to the interactive object from the participant device through the streaming channel, wherein the streaming channel comprises a video data channel and a shared data channel.

16. A system comprising:
at least one processor; and
at least one non-transitory computer-readable medium comprising instructions that, when executed by the at least one processor, cause the system to:
conduct, by a client device, a video call with a participant device through a streaming channel established for the video call from the participant device;
render, within a video call interface displayed on the client device, a video cell portraying a video utilizing video data received from the participant device in a grid-view display format; and
upon detecting a user interaction indicating a request to display a custom video call interface layout, render the video cell within a custom video call interface on the client device in a self-view display format.

17. The system of claim 16, wherein rendering the video cell within the custom video call interface comprises modifying a visual property of the video cell or applying a movement property to the video cell based on the custom video call interface.

18. The system of claim 17, further comprising instructions that, when executed by the at least one processor, cause the system to:
generate a video texture from the video utilizing the video data received from the participant device; and
fit the video texture within the modified video cell.

19. The system of claim 16, further comprising instructions that, when executed by the at least one processor, cause the system to:
render the custom video call interface by rendering an interactive object within the custom video call interface, wherein the interactive object comprises a material, an electronic paint application, an electronic document application, digital content streaming application, a video game application, a music development application, or a media browsing library application; and
update the interactive object upon receiving a user interaction corresponding to the interactive object.

20. The system of claim 16, further comprising instructions that, when executed by the at least one processor, cause the system to render the custom video call interface in the self-view display format to render the video cell of the video corresponding to the participant device via a camera buffer view of the client device.
